(19) United States
(12) Patent Application Publication
(10) Pub. No.: US 2005/0272013 A1
(43) Pub. Date: Dec. 8, 2005

(54) Process of relaying a story having a unique plot

(76) Inventor: Andrew F. Knight, Vienna, VA (US)

Correspondence Address: ANDREW F. KNIGHT, 2770 AIRLINE GOLDMINE RD., CANON, GA, 30520, US

(21) Appl. No.: 10/861,849

(22) Filed: Jun. 7, 2004

(51) Int. Cl. G09B 19/00

(52) U.S. Cl. 434/156

(57) ABSTRACT

A process of relaying a story having a timeline and a unique plot involving characters includes indicating that a first character voluntarily enters a virtual reality, indicating a belief by the first character that he or she first character is not in virtual reality, and indicating that an interaction in virtual reality between the first character and a second character, while the first character has the belief, causes the first character to labor for, at most, a compensation substantially lower than a market value of the first character's labor.

### BACKGROUND

Hollywood has been failing. Hackneyed plots are commonplace in modern movies and creativity has been replaced by expensive “special effects.” Elaborate explosions and sophisticated fight scenes bore even the slightest intellect where the storyline is confused, dull, or lacking. There is a substantial need for original, intellectually exciting plots in all forms of entertainment, such as novels and, particularly, motion pictures.

Traditionally, patent protection has provided the economic and moral impetus for technological improvements in all fields. An inventor is motivated to absorb the substantial financial, time, and personal costs of identifying problems with current technologies and inventing solutions to those problems when he is assured the right to exploit that invention by excluding others from making, using, selling, offering to sell, and importing his invention. 35 U.S.C. §271. Where patent protection is not available or is not easily obtained or enforced, such as in the typically statist welfare countries of Central and South America and communist countries such as China, technological progress is stunted by at least two causes: a) inventors employed by a company little motivation to disclose their inventions to the public, and thus tend to keep their inventions as trade secrets within the company; and b) independent inventors have virtually no motivation whatsoever to disclose their inventions to anyone, because of (justifiable) fears of appropriation.

In much the same way, the progress of intelligent fictional plots, particularly of movies, has been stunted worldwide. Currently, a writer may receive free, comprehensive, and automatic copyright protection on anything she writes. If her skill consists primarily of expressing old, stale concepts in new, creative, exciting ways, then she will benefit from copyright protection. However, if her skill consists primarily of inventing new and unique broad concepts, then copyright protection will only protect one of uncountably many possible expressions of those new and unique concepts. This dangerous dichotomy is explained further.

Patents and copyrights aim to protect different interests. A copyrighted work is a particular expression or embodiment of a broader concept. For example, a broad concept might be, “Life is worth living for its own sake, and the only economic system that respects humans' right to live freely for their own happiness, without brute force compulsion to be sacrificed for the benefit of others, is capitalism.” A particularly beautiful expression of this broad concept is Ayn Rand's Atlas Shrugged, which is subject to copyright protection. Ayn Rand's estate does not own all embodiments of the broad concept—only the single expression embodied by her novel.

In sharp contrast, a patented invention protects each and every possible embodiment of a broad invention. Consider a patent on a car. It is not a particular actual car that is the subject of a patent, rather the wide class of possible cars that fall within the scope of the patent. In other words, a particular car is simply one protected embodiment of the broader patented invention. Because of the broad scope of rights afforded to a patent owner, one may not receive a patent on an invention that is old or obvious. 35 U.S.C. §§102-103.

Thus, patent protection and copyright protection differ substantially on the ease with which infringement may be avoided. Because a patent protects all expressions or embodiments of the single broad invention, a competitor who desires to use or sell the invention without paying royalties may not; it may only avoid patent infringement by paying royalties or avoiding the invention altogether. In sharp contrast, a competitor who desires to use the broad concept disclosed in another's work (e.g., book or article) may freely do so without infringing any copyrights, even when the broad concept is new and nonobvious. All the competitor must do is to create a moderately different expression of the broad concept.

It is clear that copyrights protect those who are good performers: those who sing well, dance well, write well, act well, and so forth. Copyrights are based on a system of recognition in which society rewards performers because they express an old concept in an original (and hopefully desirable) way, not because they express a new concept. Of course, many artists do invent original concepts, but it is their expression of those concepts, not their creation or invention of those concepts, that copyright protection rewards.

For example, one who sings a touching version of “White Christmas” may receive copyright protection on his performance—not because he invented the concept of singing about Christmas—not because he wrote the lyrics to the song—but because his particular vocal expression of it is original. Further, a woman who writes and performs a love song may receive copyright protection on both the lyrics and her performance—not because she invented the concept of singing about love—but because her particular written expression of love, and her particular vocal expression of those written lyrics, are original. Finally, consider the man who invents an entirely new and nonobvious type of music or method of performing music. Clearly, copyright law cannot protect his invention. His only possible resource—which, to date, has not been tapped for the field of artistic inventions, such as original movie plots and new types of artistic expression—is patent protection.

There is no reason—neither statute nor case law nor PTO practice—why artistic inventions are not patentable subject matter under 35 U.S.C. §101. In the landmark decision Diamond v. Chakrabarty (447 U.S. 303, 1980), the Supreme Court held that living creatures were patentable subject matter under the doctrine that statutory subject matter includes “anything under the sun that is made by man,” with three exceptions: laws of nature, physical phenomena, and abstract ideas. According to the Manual of Patent Examining Procedure, these three exceptions recognize that subject matter that is not a practical application or use of an idea, a law of nature, or a natural phenomenon is not patentable. §2106 (IV)(A).

Certainly a movie implementing a unique plot is a practical application or use of the unique plot, so the unique plot should not be barred patentability under §101. The invention of a new plot is just that—an invention—not merely an expression of an existing concept. Similarly, the practical application or use of any new artistic invention should be patentable subject matter.

The fact that each particular expression (e.g., a movie) of a broad artistic invention (e.g., an original plot) is subject to copyright protection is not unique to artistic inventions. For example, the software code on a patented software-containing disk may be copyrighted. The defining criterion separating the subject matter of patents from copyrights is not whether the subject matter is related to art—see the amusing counterexample of U.S. Pat. No. 6,213,778 to Cohen. Rather, the defining criterion is whether the subject matter is a broad concept practically applied or used (patent), or a particular instance, embodiment, expression, or performance of the broad concept (copyright).

There is little fear that artistic creation will be halted due to the enforcement of patent protection newly applied to artistic inventions. A love song composer may indefinitely continue writing love songs without worry of infringing any patent, because the concept of writing songs about love is old and not patentable. Statute clearly requires an invention to be new and nonobvious to receive patent coverage. Thus, even if the broad concept or invention of singing about love were statutory subject matter under §101, it is as old as civilization, and would not survive an attack under §§102-103. In fact, most artistic concepts today are very old—which is precisely the problem that must be remedied by patent protection for artistic inventions. Unless patents on artistic inventions are upheld and enforceable, the great artistic minds of the day will be compelled to continue composing predictable love songs for pop stars and slightly altered dialogues for carbon copied movie plots.

There is currently little motivation for artistic inventors to innovate new plots, themes, and methods of expression. The value of an innovator's copyright, if he in fact embodies his invention in a particular expression (such as a novel or movie) is far less than the value of the invention itself, because the invention umbrellas every possible embodiment. Further, and perhaps more importantly, the value of his copyright depends on his ability as a performer, not as an inventor. An artistic inventor who invents a fantastically original and compelling plot may not be a particularly skilled writer. He may, for example, have a very limited vocabulary and a poor understanding of grammar. Any book he creates will be avoided by any potential buyer who reads the first paragraph, such that the copyright value of his extremely valuable invention is nil. Any Hollywood producer who sees through the book's garbled sentence structure to the excellent and creative plot beneath the surface may steal the only value the book contained: its inventive plot. The producer may then moderately alter the expression of the plot in a subsequent movie—while keeping the plot's essence fully intact—and obtain unearned financial benefit from the inventor's unrewarded hard work and innovation. If there is any evil that the United States patent system ought to prevent, it is this.

Said another way: the value of a singer's performance or a dancer's performance or a writer's performance or an artist's performance is in the performance, while the value of an inventor's invention is in the invention, not a single instance, embodiment, expression, or performance of the invention. The value of a performance is protected by copyright; the value of an invention is not. An artistic innovator is given but two choices absent patent protection: to sacrificially innovate for the unearned benefit of thieves, or to not innovate. Both options are morally and practically repulsive.

A patent system that sanctions and defends patents on artistic inventions, such as new and nonobvious plots, will spur an array of never-seen-before, never-experienced-before, intellectually inspiring forms of entertainment. A patent system that lethargically clings to an as-of-yet unarticulated rule that artistic inventions are not patentable subject matter because they are not closely enough related to a mechanical gear or an electronic integrated circuit will guarantee our nation the same repertoire of mind numbing movies and dime-a-dozen boy bands.

Virtual reality, particularly that generated by electronic human-computer interfaces, is relatively new, and has not been sufficiently exploited in new, interesting, stimulating plots in movies, books, and other forms of entertainment. Movies such as The Matrix and The Thirteenth Floor are among the few movies that have successfully incorporated virtual reality (and its potentially quirky effects) into their plots.

### SUMMARY OF THE INVENTION

The present invention aims to solve one or more of these and other problems.

In one embodiment, a process of relaying a story having a timeline and a unique plot involving characters comprises: indicating that a first character voluntarily enters a virtual reality, such as electronically generated virtual reality; indicating a belief by the first character that the first character is not in virtual reality; and indicating that an interaction in virtual reality between the first character and a second character, while the first character has the belief, causes the first character to labor for, at most, a compensation substantially lower than a market value of the first character's labor.

In one aspect, the process further comprises indicating that the first character regularly enters and exits virtual reality. In one aspect, the process further comprises indicating that the virtual reality comprises a complete virtual reality, whereby substantially all visual experiences experienced by the first character in the virtual reality are generated by at least one virtual reality display. In one aspect, the process further comprises indicating that the virtual reality comprises a partial virtual reality, whereby visual experiences experienced by the first character in the virtual reality are caused by superimposing images from at least one virtual reality display onto an actual reality.

In one aspect, the interaction comprises the second character threatening the first character. In one aspect, the interaction comprises the second character deceiving the first character. In one aspect, the interaction comprises the second character deceiving the first character into believing that the first character will labor for at least one of an false entity, a false price, and a false cause substantially different from a corresponding one of an actual entity, an actual price, and an actual cause. In one aspect, the interaction comprises the second character indicating to the first character that the second character is a religious agent who desires labor from the first character to help further a worthy cause. In one aspect, the interaction comprises the second character indicating to the first character that the second character is a government agent who desires labor from the first character. In one aspect, the interaction further comprises the second character indicating that the labor is desired from the first character to help fulfill a secret government mission to further a worthy cause.

In one aspect, the process further comprises indicating that the labor is not desired to help fulfill a secret government mission to further a worthy cause, whereby the first character is deceived by the second character. The worthy cause may comprise combating an evil, the evil comprising a use of virtual reality to cause laborers to labor for, at most, compensations substantially lower than market values of their labors.

In one aspect, the process further comprises: indicating that entities regularly buy and sell labor on a market; and indicating that at least some of the labor is performed by laborers who labor for, at most, compensations substantially lower than market values of their labors. The labor may be at least one of substantially anonymous and substantially pseudonymous. In one aspect, the process further comprises indicating that the fact that at least some of the labor is performed by laborers who labor for, at most, compensations substantially lower than market values of their labors is not known to at least a majority of the entities. In one aspect, the process further comprises indicating that the at least a majority of the entities regularly pay a labor fee for the labor.

In one aspect, the process further comprises: indicating that entities regularly buy and sell labor on a market; and indicating that at least some of the labor is performed by laborers who believe they labor for at least one of a false entity, a false price, and a false cause substantially different from a corresponding one of an actual entity, an actual price, and an actual cause. In one aspect, the process further comprises indicating that a profiteer profits by selling the at least some of the labor performed by the laborers on a market and at least maintaining the laborers' beliefs that they labor for the at least one of a false entity, a false price, and a false cause. In one aspect, the process further comprises indicating the profiteer becoming a captured laborer.

In one aspect, the process further comprises indicating that the fact that at least some of the labor is performed by laborers who believe they labor for the at least one of an false entity, a false price, and a false cause is not known to at least a majority of the entities. In one aspect, the process further comprises indicating that the at least a majority of the entities regularly pay a labor fee for the labor. In one aspect, the process further comprises indicating that the first character is one of the laborers. In one aspect, the process further comprises indicating the first character learning that the first character is one of the laborers. In one aspect, the process further comprises indicating the first character learning that the first character is one of the laborers at least in part by the first character accidentally purchasing the first character's own labor on the market.

In one aspect, the process is a process of displaying a motion picture having a timeline and a unique plot, comprising: displaying a video representation of an actor acting as the first character; displaying a video representation of the actor indicating the first character voluntarily entering a virtual reality; displaying a video representation of the actor indicating the belief by the first character that the first character is not in virtual reality; and displaying a video representation of an indication that that an interaction in virtual reality between the first character and the second character, while the first character has the belief, causes the first character to labor for, at most, a compensation substantially lower than a market value of the first character's labor.

In one aspect, the process is a process of creating a motion picture having a timeline and a unique plot, comprising: providing a set; providing a video camera configured to video at least a portion of the set; inciting an actor to act as the first character; inciting the actor to indicate the first character voluntarily entering a virtual reality; creating a first video segment via the video camera by filming the indication of the first character voluntarily entering a virtual reality; inciting the actor to indicate the belief; creating a second video segment via a video camera by filming the indication of the belief by the actor; inciting the actor to indicate engaging in the interaction; creating a third video segment via a video camera by filming the indication of the engaging by the actor; editing and combining at least part of at least the first, second, and third video segments to form a motion picture; and storing the motion picture on an information storage medium.

In one aspect, the invention includes a program product for relaying a story having a timeline and a unique plot involving characters, the product comprising machine-readable program code for causing, when executed, a machine to perform the process as described herein.

In one aspect, the process further comprises: indicating that entities regularly buy and sell labor on a market, the labor being at least one of substantially anonymous and substantially pseudonymous; indicating that at least some of the labor is performed by captured laborers, wherein a captured laborer is one who: a) labors for, at most, a monetary compensation substantially lower than market values of his or her labor; and b) believes he or she labors for at least one of a false entity, a false price, and a false cause substantially different from a corresponding one of an actual entity, an actual price, and an actual cause; indicating that the interaction causes the first character to become a captured laborer; and indicating the first character learning that the first character is a captured laborer, wherein the virtual reality is electronically generated.

In one aspect, the interaction comprises the second character deceiving the first character into believing that the first character will labor for the at least one of a false entity, a false price, and a false cause. In one aspect, the interaction comprises the second character indicating to the first character that the second character is a government agent who desires labor from the first character to help fulfill a secret government mission to combat an evil, the evil comprising a use of virtual reality to cause laborers to labor for, at most, compensations substantially lower than market values of their labors. In one aspect, the process further comprises indicating that the labor is not desired to help fulfill a secret government mission to further a worthy cause, whereby the first character is tricked by the second character. In one aspect, the process further comprises indicating that the fact that at least some of the labor is performed by captured laborers is not known to at least a majority of the entities. In one aspect, the process further comprises indicating the first character learning that the first character is one of the laborers at least in part by the first character accidentally purchasing the first character's own labor on the market.

According to another embodiment, a process of relaying a story having a timeline and a unique plot involving characters comprises: indicating that entities regularly buy and sell labor on a market; indicating that at least some of the labor is performed by captured laborers, wherein a captured laborer is one who: a) labors for, at most, a monetary compensation substantially lower than a market value of his or her labor; and b) believes he or she labors for at least one of a false entity, a false price, and a false cause substantially different from a corresponding one of an actual entity, an actual price, and an actual cause; indicating that an interaction between a first character and a second character causes the first character to become a captured laborer, wherein the interaction comprises the second character deceiving the first character into believing that the first character will labor for at least one of a false entity, a false price, and a false cause; and indicating the first character learning that the first character is a captured laborer.

In one aspect, the process further comprises indicating that a profiteer profits by selling the at least some of the labor performed by the captured laborers on the market and at least maintaining the captured laborers' beliefs that they labor for the at least one of a false entity, a false price, and a false cause. In one aspect, the process further comprises indicating the profiteer becoming a captured laborer. The monetary compensation may be substantially zero.

In one aspect, the process further comprises indicating the first character learning that the first character is a captured laborer at least in part by the first character purchasing the first character's own labor on the market. The first character's belief that the first character will labor for the at least one of a false entity, a false price, and a false cause may be at least one of caused and maintained by an electronically generated virtual reality. In one aspect, the process further comprises indicating that the first character regularly enters and exits the virtual reality. In one aspect, the process further comprises indicating that the virtual reality comprises a complete virtual reality, whereby substantially all visual experiences experienced by the first character in the virtual reality are generated by at least one virtual reality display. In one aspect, the process further comprises indicating that the virtual reality comprises a partial virtual reality, whereby visual experiences experienced by the first character in the virtual reality are caused by superimposing images from at least one virtual reality display onto an actual reality.

The interaction may comprises the second character indicating to the first character that the second character is a religious agent who desires labor from the first character to help further a worthy cause. The interaction may comprises the second character indicating to the first character that the second character is a government agent who desires labor from the first character. The interaction may comprises the second character indicating that the labor is desired from the first character to help fulfill a secret government mission to further a worthy cause.

In one aspect, the process further comprises indicating that the labor is not desired to help fulfill a secret government mission to further a worthy cause, whereby the first character is tricked by the second character. The worthy cause may comprise combating an evil, the evil comprising a use of virtual reality to cause laborers to labor for, at most, monetary compensations substantially lower than market values of their labors. At least some of the labor may be at least one of substantially anonymous and substantially pseudonymous.

In one aspect, the process further comprises indicating that the fact that at least some of the labor is performed by captured laborers is not known to at least a majority of the entities. In one aspect, the process further comprises indicating that the at least a majority of the entities regularly pay a labor fee for the labor. In one aspect, the process further comprises indicating that the interaction occurs in an electronically generated virtual reality while the first character believes that the first character is not in virtual reality.

The process may be a process of displaying a motion picture having a timeline and a unique plot, comprising: displaying a video representation of an indication that entities regularly buy and sell labor on a market; displaying a video representation of an indication that at least some of the labor is performed by the captured laborers; displaying a video representation of an indication that the interaction between the first character and the second character causes the first character to become a captured laborer; and displaying a video representation of an indication of the first character learning that the first character is a captured laborer.

The process may be a process of creating a motion picture having a timeline and a unique plot, comprising: providing a set; providing a video camera configured to video at least a portion of the set; inciting an actor to act as the first character; inciting the actor to indicate engaging in the interaction; creating a first video segment via a video camera by filming the indication of the engaging by the actor; inciting the actor to indicate the first character learning that the first character is a captured laborer; creating a second video segment via the video camera by filming the indication of the first character learning; editing and combining at least part of at least the first and second video segments to form a motion picture; and storing the motion picture on an information storage medium.

According to another embodiment, a process of relaying a story having a timeline and a unique plot involving characters comprises: indicating a first character laboring for a compensation comprising a monetary portion and a belief; indicating that a market value of the monetary portion is substantially less than a market value of the first character's labor; indicating that a profiteer profits by selling the first character's labor on a market and compensating the first character by at least maintaining the belief using an electronically generated virtual reality; and indicating the first character learning that the belief is false.

The interaction may comprise the second character deceiving the first character into believing that the first character will labor for at least one of an false entity, a false price, and a false cause substantially different from a corresponding one of an actual entity, an actual price, and an actual cause. In one aspect, the process further comprises indicating that the interaction occurs in an electronically generated virtual reality while the first character believes that the first character is not in virtual reality.

The interaction may comprise the second character indicating to the first character that the second character is a religious agent who desires labor from the first character to help further a worthy cause. The interaction may comprise the second character indicating to the first character that the second character is a government agent who desires labor from the first character. The interaction may comprise the second character indicating that the labor is desired from the first character to help fulfill a secret government mission to further a worthy cause.

In one aspect, the process further comprises: indicating that entities regularly buy and sell labor on a market; indicating that at least some of the labor is performed by captured laborers, wherein a captured laborer is one who: a) labors for, at most, a monetary compensation substantially lower than a market value of his or her labor; and b) believes he or she labors for at least one of a false entity, a false price, and a false cause substantially different from a corresponding one of an actual entity, an actual price, and an actual cause; and indicating that the first character is one of many captured laborers.

The process may be a process of displaying a motion picture having a timeline and a unique plot, comprising: displaying a video representation of an indication of the first character laboring for the compensation; displaying a video representation of an indication that a market value of the monetary portion is substantially less than a market value of the first character's labor; displaying a video representation of an indication that the profiteer profits by selling the first character's labor on a market and compensating the first character by at least maintaining the belief using an electronically generated virtual reality; and displaying a video representation of an indication of the first character learning that the belief is false.

The process may be a process of creating a motion picture having a timeline and a unique plot, comprising: providing a set; providing a video camera configured to video at least a portion of the set; inciting an actor to act as the first character; inciting the actor to indicate laboring for the compensation; creating a first video segment via a video camera by filming the indication of the laboring by the actor; inciting the actor to indicate the first character learning that the belief is false; creating a second video segment via the video camera by filming the indication of the first character learning; editing and combining at least part of at least the first and second video segments to form a motion picture; and storing the motion picture on an information storage medium.

According to another embodiment, a process of relaying a story having a timeline and a unique plot involving characters comprises: indicating that entities regularly buy and sell labor on a market; indicating a first character laboring for a compensation comprising a monetary portion and a belief; indicating that a market value of the monetary portion is substantially less than a market value of the first character's labor; indicating that a profiteer profits by selling the first character's labor on a market and compensating the first character by at least maintaining the belief; indicating the first character learning that the belief is false at least in part by the first character purchasing the first character's own labor on the market.

The process may be a process of displaying a motion picture having a timeline and a unique plot, comprising: displaying a video representation of an indication that entities regularly buy and sell labor on a market; displaying a video representation of an indication of the first character laboring for the compensation; displaying a video representation of an indication that a market value of the monetary portion is substantially less than a market value of the first character's labor; displaying a video representation of an indication that the profiteer profits by selling the first character's labor on a market and compensating the first character by at least maintaining the belief; and displaying a video representation of an indication of the first character learning that the belief is false at least in part by the first character purchasing the first character's own labor on the market.

The process may be a process of creating a motion picture having a timeline and a unique plot, comprising: providing a set; providing a video camera configured to video at least a portion of the set; inciting an actor to act as the first character; inciting the actor to indicate laboring for the compensation; creating a first video segment via a video camera by filming the indication of the laboring by the actor; inciting the actor to indicate the first character learning that the belief is false; creating a second video segment via the video camera by filming the indication of the first character learning; editing and combining at least part of at least the first and second video segments to form a motion picture; and storing the motion picture on an information storage medium.

Any of the described embodiments and aspects may be “mixed and matched” where possible.

### DETAILED DESCRIPTION

The following described plot may be applied to any form of entertainment, including motion pictures (movies), books, plays, television movies or episodes, radio shows, and may further be applied to any form of media, including video, audio, or written commercial advertisements, video, audio, or written news, etc.

One possible embodiment of the present plot or storyline will now be described. Any variations that are within the skill of one of ordinary skill in the art are within the scope of the present invention. The setting is an industrialized city or suburb in the not-too-distant future, such as 10 to 20 years from now. Information storage, transfer, and computation technology has matured to the point that realistic virtual realities are readily accessible. The protagonist, whose name may be Eric, is preferably a software programmer, although he may have any occupation that may be substantially performed in a virtual reality setting. Eric may also be married and have one or more children.

Given sufficient virtual reality software maturity, many occupations could be performed in virtual reality. For example, any occupation whose added value comes from mental processing, analysis, or innovation (as opposed to those whose added value comes from manual labor) may be performed in a virtual reality setting. In fact, even some “manual labor” occupations may be substantially performed in a virtual reality setting. For example, a farmer's property may be farmed by robotic and remotely controlled machines, and the farmer may control these machines by entering into a virtual reality setting in which he rides a corresponding virtual reality machine, such as a virtual reality tractor. The actual or real tractor may include cameras and other feedback mechanisms that are fed to the farmer via an information network, and the farmer may wear a stereoscopic head-mounted video display having stereo earphones and configured to display video and emit sounds corresponding to those detected by the camera(s) and microphone(s) attached to the actual tractor. Based on this information, the farmer may enter information into an input device (that may correspond to the controls on the tractor), which information is sent to control the actual tractor. This is just one example in which the “real world” may be controlled at least in part by commands and operations performed by laborers in virtual reality. One of ordinary skill in the art will understand how various “manual labor” type occupations may be performed using the application of an input-output virtual reality setting communicatively linked to a robot that performs the actual tasks.

For most mental processing, analysis, or innovation occupations, the laborer may enter a virtual office and sit at a virtual desk and/or virtually interact with others in the virtual reality setting. There, the laborer receives the necessary input information from the appropriate provider (e.g., supervisor or customer), subsequently analyzes and/or processes the information, and produces and transmits to the appropriate recipient (e.g., a supervisor or customer) a finished work product in the virtual reality setting. Again, one of ordinary skill in the art will recognize how such brain intensive occupations may be performed using the application of an input-output virtual reality setting communicatively linked to the provider(s) of information and the recipient(s) of the finished work product.

Thus, Eric, like millions of other laborers, goes to work by entering into a virtual reality setting. For example, he may have a designated virtual reality room in his home, in which he dons a virtual reality generating device having a stereoscopic head-mounted display and stereo headphones, configured to produce a three-dimensional image in his eyes and produce stereoscopic sound in his ears. The virtual reality generating device, or another device in his virtual reality room, may also have input devices such as video cameras, microphones, etc., and may include a processor, an information storage, a network connection, an animating and/or virtual reality generating software, etc. Of course, the virtual reality generating device(s) may have sensors and generators corresponding to other senses, such as tactile, olfactory, and taste. After donning the device, he may then communicatively link himself to an information network in which virtual reality information is passed between himself and various other contacts, such as his employer, his co-workers, his customers, and so forth. Thus, an entire virtual office, looking and sounding substantially like an ordinary “real” office where one may interact with one's employer, co-workers, etc., may be produced by the virtual reality generating device and the processor, animating software, etc. Physical motions, such as standing up, sitting down, walking over to a co-worker's virtual office, pressing buttons on a virtual keyboard, etc., could also be sensed and measured in his virtual reality room via cameras and position sensors, and this information could be fed into the virtual reality processor so that Eric's virtual body moves in accordance with his actual movements. Of course, the body movements of the various people in his virtual office may also correspond to their actual movements in a similar way. He may then exit the virtual reality, e.g., by speaking a corresponding command (which is recognized by a voice recognition software in the virtual reality processor), or by “pressing a button” in the virtual reality environment, or by thinking a particular thought (such as exiting), if such brain-reading technology is believably available in the time period of the present plot.

While the virtual reality generating device may comprise a head-mounted display, more expensive hardware exists that allows a high-resolution display (possibly also including a high-resolution video camera) to be mounted directly on one's eyeball, such as by a permanent, surgically applied mount, or a non-permanent mount (in much the same way a conventional contact lens is non-permanently mounted on one's eyeball). The display may be a typical pixel-type display (such as a liquid crystal display, or LCD), but is preferably transparent when the display is not being used. Further, preferably, each individual pixel may be made transparent when not used to form a color or image. Thus, each display may be used to form a complete visual virtual reality such that the entire display (e.g., all or substantially all pixels) displays an image, so that substantially all visual experiences experienced by the person having the displays in his eyes are generated by the displays. Further, each display may alternatively or in addition be used to form a partial visual virtual reality such that only a portion of the display (e.g., a fraction of the pixels) displays an image, so that only some of the visual experiences experienced by the person having the displays in his eyes are caused by the displays—i.e., the displays superimpose images onto images from the “real” world.

The same is preferably true of speaker (and possibly microphone) technology that may be permanently or non-permanently mounted in one's ears. For example, the speaker may be configured to allow other sounds to pass to the person's ears, so that the sounds created by the speakers are superimposed onto the sounds from the “real” world—i.e., a partial auditory virtual reality. Or, the speaker may include noise-cancellation technology to cancel out sounds from the “real” world, thus allowing the person to hear only the sounds created by the speakers—i.e., a complete auditory virtual reality.

Further, virtual reality need not be used only for working—it may also be used for playing. For example, a young adult may enter a virtual dance club in her own home. Alternatively, she may visit a physical dance club with hundreds of other young adults, the club located inside an empty building. Her displays may be configured to be transparent where a person is located, but to display an interesting, lively ambiance in other regions, so that she clearly sees the other people in the building, but the dry, emptiness of the building's inside is masked by a superimposed ambiance, which may be created and transmitted to her by the dance club's management or employees.

This world of the future is unique in another manner. Current businesses suffer from many costs, including the costs of renting and maintaining a business location and offices or cubicles for its employees. Further, the transaction costs of finding, hiring, and (if necessary) firing employees may be excessive, so that often employees remain with a company with which they are unhappy, and companies often retain inferior or low productivity employees, because quitting and moving to another company (or firing an employee and finding a replacement) are time and money intensive. In this world of the future, because most laborers can now work at home in a virtual office, the transaction costs of commuting, changing jobs, replacing employees, etc., are almost eliminated.

Here is an example, a nuclear engineer may post his education, qualifications, experience, references (and optionally his name and contact information) with an electronic employment search engine. The engineer may be available at a particular price per hour or other time, or per project, and the price may be set by himself or by a company that manages many nuclear or other engineers. When a company has a problem that is best solved by a nuclear engineer, the company electronically hires the engineer by buying his time. The nuclear engineer may then “show up” to work in a virtual reality office created by software provided by himself or the company who hired him, and he may interact with his temporary employer and co-workers, etc., in the virtual environment. Alternatively, the nuclear engineer may not virtually meet with anyone in his hiring company, and may simply be forwarded his instructions and the problem to solve electronically. The nuclear engineer may then enter his office (whether or not a virtual office), work on the problem, and forward his final work product to the hiring company. When completed, the nuclear engineer is paid either directly by the company or via an intermediary company, and the nuclear engineer again posts his resume on the electronic employment search engine.

In this future world, companies need not pay for hiring/firing transaction costs, commuting costs (which, while currently directly borne by most employees, are ultimately passed on to the employers because companies to which commuting costs are less may pay correspondingly reduced salaries in a free market), and “down time” (the time in which an employee does not have work to do, but in which the employee is nevertheless paid his normal salary because the transaction cost of laying off the employee and subsequently rehiring the same or a different employee exceeds the salary paid the employee during this down time). Thus, in this future world in which each professional has his or her own virtual office at home and whose employment may quickly change with few or no transaction costs, the total price that a company can afford to pay an employee per hour or project is far greater than currently possible. Thus, the benefits of no transaction costs and virtual commuting are ultimately passed onto the employees/laborers themselves, who can now produce the same quantity of wealth in substantially less actual work time. Such a world is, in fact, likely to evolve over time, due to its massive wealth savings. Present-day consultants represent a first-cut implementation of this methodology.

Having explained the advanced devices and methodologies of the time setting, the present plot according to one possible embodiment will be further described. One night, while Eric is asleep (and perhaps his wife and children are out of town), a person gases him, such as by plumbing a supply of laughing gas, or other gas causing similar effects, into his bedroom to prevent Eric from waking up. Alternatively, of course, Eric need not be in his home, and it need not occur in the middle of the night. In a quick, relatively undetectable operation, the perpetrator (preferably permanently) mounts a small video display (and/or video camera, as discussed) into each of Eric's eyeballs, and a small speaker (and/or microphone, as discussed) into each of Eric's ears. Also, preferably, the devices include input receivers (and/or output transmitters) that may utilize any form of information transmission (fictional or not), such as radio, light, infrared energy, etc., so that information may be received remotely and used to generate a virtual reality setting for Eric via the displays and speakers (and possibly so that information may be sensed and transmitted from the cameras and microphones). Eric awakes with a slight headache, but does not otherwise detect any foul play.

The perpetrator may also, while in Eric's house, have uploaded software, such as a virus, to the virtual reality processor in Eric's house. Alternatively or in addition, the software may be intentionally uploaded to Eric's virtual reality processor as a virus or other executable program via the information connection while Eric is “online” in his virtual reality office. After Eric is done with his next day of work, and after he “exits” the virtual reality by performing the appropriate disconnect or exiting option, he sees a person (the antagonist, whose name may be Mr. Chase) sitting in the virtual reality room (a real room in Eric's home) with him. Unbeknownst to Eric, Mr. Chase is not actually in Eric's home. The permanently mounted displays and speakers in Eric's eyes and ears have been used to generate a partial virtual reality, partial in the sense that the displays are used to superimpose a three-dimensional image of Mr. Chase onto the visual images otherwise experienced by Eric, so that every aspect of Eric's view of his room is accurate, except the appearance of Mr. Chase on a chair in the middle of the room.

In an alternative embodiment to that described above, if the devices in Eric's eyes included high-resolution video cameras, then over the course of one evening (after a day of work in Eric's virtual reality office), the video cameras could send video information of what Eric looked at during the evening via the information transmission connection discussed previously. This information could then be used by a human programmer, or by intelligent animating or virtual reality generating software, to paint a complete (as opposed to partial) virtual reality setting that is substantially indistinguishable from the real setting Eric would normally experience after exiting his virtual reality office. Then, an image of Mr. Chase could be included in that virtual reality setting, so as to give an effect similar to that described above, with the exception that the virtual reality setting is complete, not partial.

Continuing with the plot according to a possible embodiment, Eric is extremely surprised and terrified by the man sitting before him, uninvited and unannounced in his home. Eric, who does not know about the displays mounted in his eyeballs, through which the image of Mr. Chase is remotely received (e.g., from a remote transmitter or from Eric's virtual reality processor, itself, due to the unauthorized uploaded software or virus) and displayed, has no reason to doubt the reality of Mr. Chase's apparition. Mr. Chase is preferably around 40 years of age, wears a dark, expensive suit, and is armed with a handgun. He quickly introduces himself and identifies himself as a government agent (such as from the Central Intelligence Agency), and explains that he is on a very secret mission and needs Eric's help to pursue a worthy cause. Mr. Chase is very intimidated, at least in part because of his handgun, so Eric remains seated and listens.

The worthy cause could be any cause that successfully sways Eric to help Mr. Chase. One such embodiment will be described here, although many causes that some people consider to be worthy (e.g., reducing hunger, educating children, eliminating or treating diseases such as cancer, ensuring a clean environment, protecting the existence of some obscure species of lizard in the valleys of Nepal, etc.) are known in the art and are within the scope of the present invention. Mr. Chase explains that a virus has been unleashed on the worldwide information network that has resulted in millions of people being enslaved by their virtual reality programs, and that he needs Eric's help as a software programmer to perform various tasks and solve various problems that may or may not appear to be related to freeing those who are currently enslaved.

As one example, Mr. Chase may assert that people are enslaved by the software in the following manner. A person enters his virtual reality office for a day at work, at the end of which he attempts to leave the virtual office. At that point, the viral software generates a virtual reality that mimics the person's actual room or home, so that the person is not immediately aware that he has remained in virtual reality. Then, the viral software creates apparitions of one or more armed men who appear to the person to be in his actual home, in his “actual” world, and who forcefully threaten him (e.g., by pointing guns at him) to obtain various favors. They may threaten to kill or torture him or his friends/family, and because he is so petrified, and because the entire transaction lasts a very short time, he does not have the suspicion, time, or courage to determine whether he has remained in the virtual reality. For example, if the virtual reality generating device utilizes only visual and auditory information, the person may be able to discover that the men are apparitions by reaching out to touch them, in which case his hand would pass through them, and so forth. For another example, if he must wear a head-mounted display to experience the virtual reality, the men may loudly threaten, “Stay where you are—don't move—keep your hands down.” The person may not then have the suspicion or opportunity to see whether or not they are real.

In other words, it appears to the person that he is being forcefully threatened, and he is then willing to obey their commands. They command that he re-enter the virtual reality office (even though he is, unbeknownst to him, already in a virtual reality environment or setting) and begin working for a new dictatorial boss. They explain to him that he must work for this boss for a predetermined amount of time (preferably not life, because someone enslaved for life may prefer to simply die), such as 2 or 5 or 10 years, at which point he will be freed, and will remain safe from their wrath unless and until he discloses his slavery to anyone (including his wife, children, or other friends/family). The person then “re-enters” his virtual reality office, believing the entire time that the violent threats had been a real event, and “meets” the new dictatorial boss who will give him various orders and assignments for the predetermined time. After leaving the virtual reality office for the day, the person is then convinced that he and his family are being watched and continuously threatened in the real world, and so he continues to work for the predetermined time to ensure the safety of himself and his family. During the predetermined time, a similar event may regularly occur to keep the person in constant fear of the danger of failing to show up for work or exposing the slavery.

Having explained how the software can be used to enslave people to work for no pay (or possibly only enough pay to cover various bills such as rent, to make interference by wives or other family members less likely) by making them believe a violent fiction, Mr. Chase then explains how the software is implemented by profiteers. An entity (a person or company) will hire a person and, during the initial electronic connection (e.g., internet connection) between the person and the hiring entity, the entity will upload the viral software into the person's virtual reality processor and/or storage, which then executes and enslaves the person. Then, the enslaving entity acts as an intermediary company, “renting” out the person to other entities, who then pay the enslaving entity the market value of the person's labor. The other entities do not know that the person is enslaved, and simply assume that the enslaving entity is one of many legitimate intermediary companies (which could ordinarily and lawfully act as trade unions and the like) who pay their employees most or all of the fees collected by “renting” the employees out. For example, a nuclear engineer might be a member of an intermediary company, which advertises its members and solicits employment by potential employers. For this service, the intermediary may rent out the nuclear engineer at $100/hour, and pay the nuclear engineer $95/hour, retaining $5/hour as a transaction or service fee. However, the enslaving entity, by virtue of its application of the enslaving software on the person, need not pay the person anything (or a very minimal amount), and thus keeps the entire fee by profiting from the person's slave labor.

Mr. Chase explains that many such companies already exist, and wonders how many millions of workers are presently secretly enslaved. He thus asks Eric to work for him to help alleviate this evil, by helping to program various software products and by working on various assignments which will be applied to the bigger assignments of: eliminating or countering the enslaving software; and catching and criminally prosecuting the enslaving entities. Mr. Chase's plea is sincere, but he explains that, because it is a secret government operation, the funds are very limited. In other words, he can only pay Eric a small fraction (such as about 10%, 25%, or 50%) of what Eric currently earns working on the open market as a software engineer. Mr. Chase gives Eric time (minutes, perhaps days) to decide, and tries to sell Eric on the noble and worthy nature of the cause—of emancipating millions of scared, helpless, unsuspecting slaves. Mr. Chase points out that Eric's own father had been recently complaining about not having enough money, and suggests that Eric's father is already enslaved. Of course, Eric eventually agrees to quit his current employment (if he has any) and take on Mr. Chase's various assignments in order to do “the right thing” to help his fellow men escape slavery. In doing so, he effectively agrees to labor for Mr. Chase for, at most, a compensation substantially lower than a market value of his labor.

The above described part of the plot should be painted very believably to the audience, whether in quality written narrative in a book, or good cinematography and acting in a movie, etc., so that the audience has every reason to believe that Mr. Chase is really in Eric's house, is really a well-intentioned secret government agent, and his explanation is believable and sympathetic. In other words, the audience should not yet suspect that the very enslaving that Mr. Chase describes has just happened to Eric (without the threat of violence).

“Compensation” and “market value of labor” will be further described here. The market value of a particular kind of labor is the value that such labor will bring in a market, preferably a well-known free marketplace. Market value may involve knowledge of a market and interaction in that market. Thus, consider a first person who sells a painting to a second person for $10, where the second person knows he can sell the same painting in a well-known art or painting marketplace for $100. The mere fact that the first person was willing to sell the painting for $10 does not imply the market value of the painting is $10, because the first person had no knowledge of or interaction in the known art marketplace. The market value is thus around $100. However, as with any market, the reputation of a seller can add or detract value from a piece in the marketplace. For example, in the above example, assume that the first person knows about the known marketplace, and offers the painting for sale in that market. Because the first person is not known in that marketplace (i.e., has a poor or nonexistent reputation), it is possible that few buyers choose to deal with the first person, for fear that the painting is a forgery or has other unknown problems. Thus, the best offer that the first person can get on the market is $10. When the second person, who may be a well known art critic, appraiser, or dealer, subsequently sells the painting for $100, the difference in price may be a value added by the second person's good reputation. Thus, the painting in the hands of the first person may be physically identical and yet substantively different from the painting in the hands of the second person; thus their market values may be different.

The same is true for labor. A freelance or consultant chemical engineer may be worth less on a known market than a chemical engineer employee of a well-known reputable chemical engineering firm. Assume the consultant may charge $100/hr for her time. Further assume that the firm may charge $120/hr for its employee's time, and the firm may pay the employee only $80/hr for the employee's time. What is the market value of the engineer's labor? Consider that the consultant's and employee's positions are not equal. The consultant accepts the costs and responsibility of finding customers, and absorbs the cost of the risk that she may fail to find sufficient work to keep her busy. These costs are absorbed by the employee's employer, so the employee need only focus on actual chemical engineering. Thus, the market value of the engineer's labor depends on the voluntary choice of the engineer—does she prefer to make more money while absorbing costs of risk and finding customers? Or does she prefer to let someone else absorb these costs? In the first case, the market value of her labor is $100/hr; in the second case it is $80/hr. In neither case (in this example) is it $120/hr, which is the price that only the reputable firm may charge.

What complicates market value further is the meaning of “compensation.” Compensation is the value of the reward received by a laborer in exchange for his labors, as subjectively valued by the laborer. While compensation is often discussed only in monetary terms, economists and those of ordinary skill in the art will recognize that compensation is the total sum of the rewards and pains (monetary or not) due to laboring in the compensated way. For example, many judges, such as federal judges, have smaller paychecks than if they worked for a private law firm. So why do they remain judges? A portion of the judges' compensations must be the enjoyment or happiness or pleasure of being judges. It must be that the judges subjectively value being judges—e.g., they may be power hungry people who love forcefully telling people what to do. More importantly, each judge must subjectively value the sum of (his paycheck) and (being a high-and-mighty judge) more than the sum of (his potential paycheck at a private law firm) and (being a lowly lawyer). Thus, the value of a judge's labor on a labor market is typically greater than the magnitude of the paycheck he receives, and is probably closer to the magnitude of the paycheck he would receive as a lawyer at a private firm. Happiness is a subjective value that may be weighed against more easily measurable values (such as money) only by the person subjectively valuing the happiness. One may be relatively certain that an attorney who quits a $200K/year job at a private law firm to collect $120K/year as a federal judge expects his increased happiness as a judge to be worth—to him—more than $80K/year.

In other words, a person who works for a valuable, worthy, particularly enjoyable, or otherwise fulfilling cause or career may be compensated greater than her paycheck indicates. In any case, the market value of a person's labor is determined by that person's subjective valuations (as measured by that person's voluntary choices) in a well-known open/free market. Exact market values of labor may be difficult to determine, but ranges of market values are very easily obtained by simply observing actual transactions on the market, because each transaction represents an actual subjective valuation of the thing being bought or sold. Thus, in the present plot, Eric has presumably voluntarily chosen to sell his labor as a software engineer to his present employer for $X (per hour, per year, whatever). Eric presumably knows about the market of software engineers. After all, information regarding what particular kinds of labor are worth on an open market travels fast and prolifically. For example, when Eric posts his resume (or education, experience, and so forth) on the previously discussed electronic labor market bulletin board, he notices the prices that various other software engineers charge as a function of their education, experience, abilities, and so forth, and he may adjust his own price based on this information. Because Eric knows about the labor market and has rationally and voluntarily chosen to accept $X for his labors, $X is, more or less, the market value of his labor.

Thus, when Eric voluntarily decides to quit his job (which pays $X) to accept employment with Mr. Chase (which pays, say, 25% $X) to pursue the worthy cause (in the present example, to help eliminate virtual-reality-induced slavery), it must be the case (assuming everything else equal and assuming that Eric is rational) that Eric values pursuit of this worthy cause at more than 75% $X—otherwise his total (or real or actual) compensation would decrease by such a voluntary decision. Accepting Mr. Chase's proposal does not decrease, or even necessarily change, the market value of Eric's labor. Rather, a portion of Eric's compensation is “paid” to Eric in the good feeling that comes from pursuing a worthy cause, which good feeling Eric subjectively values at more than 75% $X, as proven by his voluntary and rational decision to accept Mr. Chase's proposal. If Eric discovers that he has been lied to, and his labors are not actually being used to pursue this worthy cause, then Eric has effectively been robbed of this portion of his compensation, which he subjectively valued at more than 75% $X. In such a case, Eric's actual compensation is, retroactively after his discovery of the truth, only 25% $X, which is substantially less than the market value of his labor. These numbers are merely illustrations. For example, if Eric regularly sold his labor for $100/hr, but was willing to accept $90/hr when laboring for charitable organizations, then he is compensated at least $10/hr worth of good feeling when he labors for the charity. If after working for a self-identified charity for one hour, he discovers that it is not actually a charitable organization at all, then his actual compensation for that hour has dropped to $90, which is substantially less than the market value of his labor, because the (more than) $10 value in good feeling has been robbed by the organization's lie.

There are many ways of causing a person to labor for substantially less than the market value of one's labor, all of which deal with stealing all or a portion of one's labor. These ways may be divided into two types, based on the belief of the laborer: a) the laborer believes, while laboring, that theft is involved; and b) the laborer believes, while laboring, that no theft is involved.

Set a) includes slavery, extortion, kidnapping, blackmail, robbery, and common theft, among others. Set b) includes lying, cheating, fraud, and deceit, among others. Possibly the simplest way to cause a person to labor for substantially less than the market value of one's labor is forced slavery, based on physical violence or the threat of physical violence to oneself. Slavery represents the worst and most direct kind of theft: the theft of one's own person. Even the poorest man still freely owns his body and his mind, and has the power to voluntarily manipulate his body (e.g., labor, speak, socially interact, etc.) according to rational decisions to increase his happiness and to avoid pain. A slave driver is one who, using violent force or the threat of violent force, steals a person's body, thus preventing that person from voluntarily acting to increase his happiness or to avoid pain.

Thus, a slave driver may torture a slave (thus stealing the slave's power to manipulate his body to avoid the pain), and may “sell back” this power to the slave (to allow him to avoid further pain) by laboring in the manner compelled by the slave driver. Because a person typically subjectively values his own life very highly (and often more highly than any other value), a slave driver will often be able to cause the slave to perform any labor, for very long periods of time, so long as the promise or possibility remains to the slave that the slave will be released (i.e., he will earn back his own body's freedom).

A similar effect can occur with kidnapping, in which something very valuable to the laborer (such as the life or well-being of a spouse, a family member, or friend) is threatened. In the same sense, one who kidnaps a man's wife effectively steals his wife (and the value that he placed in her) from the man, and relies on the man's compliance to labor or perform some task to earn back his wife's freedom. Similar stories can be told regarding extortion and blackmail, in that something (such as a person's good reputation, or a secret that one guards to prevent being prosecuted for a crime) are stolen or taken hostage, returnable only upon the performance of a task or labor. Robbery and common theft have similar effects, in that a person must labor to earn back the thing (or a thing similar) that was stolen or robbed.

One difference is that, because the thief or robber does not typically intend to return the thing stolen, there is often no link between the thief and the person for whom labor is to be performed. Thus, the feelings that a theft victim might feel toward his “employer” in the extortion or kidnapping or slavery case will be very different than that felt toward his “employer” in the theft case. For example, a company needs an engineering problem solved, but does not have the money to pay an engineer to perform the problem. The company knows of an engineer who possesses a valuable diamond pendant. The company could break into the engineer's home and steal the pendant, leaving it with two options: 1) tell the engineer about it and offer to return it upon solving their problem (i.e., laboring for them); or 2) sell the pendant on the open market and use the proceeds to hire an engineer to solve the problem. Case 1) is extortion, while case 2) is common theft. In both cases, the engineer knows that theft is involved, and in both cases the theft causes him to labor for substantially less compensation than the market value of his labor. This is true in case 1) because the entire transaction consists of: something valuable being stolen; and laboring (for the extortionists) to earn back that valuable something. Thus, the entire transaction results in a net zero compensation to the laborer (because he is in the same position he was in prior to the theft, minus his labor), thus causing him to labor for substantially less compensation (in this case, zero compensation) than the market value of his labor. The same is true in case 2), also. In case 2), the theft victim will likely have no further contact with the thief (unlike the extortion case). However, to put the victim back in the same position he was in prior to the theft, he must labor for an employer to earn sufficient money to buy a similar diamond pendant on an open jewelry market. Thus, case 2) is like case 1) in that the entire transaction consists of: something valuable being stolen; and laboring (for an independent employer) to earn money to buy back that valuable something. Thus, the entire transaction results in a net zero compensation to the laborer (because he is in the same position he was in prior to the theft, minus his labor), thus causing him to labor for substantially less compensation (in this case, zero compensation) than the market value of his labor.

However, while similar in net result, the distinction between the two kinds of theft (in one case where the laborer knowingly labors for the thief, as with slavery, extortion, kidnapping, and blackmail, and in the other case where the laborer does not knowingly labor for the thief, as with robbery and common theft) is important. In the first case, the “thief employer” will suffer from at least two important problems. First, the laborer is likely to be very unhappy with the thief, and his work product may therefore suffer. The laborer is not likely to be very productive while working under the thief, because of resentment toward the thief's theft. Second, the thief employer is always at risk of being exposed by the laborer, and must take great pains to remain pseudonymous or to dissuade the laborer from “telling.” The second case has neither of these problems, as the laborer's employer is, to the laborer's knowledge, unrelated to the thief, so the laborer will not harbor the same resentment or disposition to “tell on” the employer.

As discussed, set b), in which the laborer believes, while laboring, that no theft is involved, includes lying, cheating, fraud, and deceit, among others. Set b) has some benefits similar to common theft and robbery, in that the laborer is likely to labor without resentment toward the employer and without disposition to expose the wrongdoing of the employer, while the laborer's belief is maintained that no theft is involved. However, such maintenance is a difficult task, particularly over long periods of time. Consider, for example, an employer who hires a laborer with an offer of compensation, however without intention of paying the compensation. Such is an example of lying, cheating, fraud, and/or deceit. The employer promises to pay compensation, e.g., biweekly. In the first two weeks, the laborer happily labors without believing that theft is involved. However, at the end of the two weeks, when the employer does not pay, the employer must further deceive the laborer into believing that the employer still intends to pay, but cannot at the moment. Eventually, however, such as after a month of two of broken promises, the employer may not be able to maintain the laborer's belief that no theft is involved, and soon the laborer will refuse to labor for the employer. The employer may be able to delay the laborer's doubt by inserting fake money into a fake bank account that is accessible by the laborer, causing the laborer to believe that he is being credited with his compensation. However, again, this belief will be difficult to maintain when the laborer attempts to access his account for purchases or cash. In order to steal large quantities of wealth (in the form of productive labor) from a person, one must maintain the laborer's belief that theft is not involved—i.e., that all or part of his labor is not being stolen.

Virtual reality may be used to efficiently, effectively, and cheaply maintain such a belief. For example, a company may promise to biweekly pay a laborer monetary compensation for his labors. At the end of each second week, the company may insert fake money into a fake bank account that is accessible by the laborer, as discussed. The company may create a virtual reality for the laborer that corresponds to the “purchases” made on the fake account, such that the laborer believes that he is redeeming real compensation for real products or services. For example, when the laborer attempts to obtain a massage by a professional masseuse, the company debits the laborer's account by a corresponding amount and initiates a virtual reality animation (which may be created via a virtual reality generating device located in the laborer's eyes, ears, skin, etc., which the laborer does not know about, as discussed above regarding Eric's secretly mounted visual displays and sound speakers) that causes the laborer to believe that he is receiving a real massage. If the cost of producing the believable virtual reality massage costs less to the company than a real massage, then the company retains that difference in cost as profit.

There is a problem with the above assumption, however. If a believable virtual reality massage could be generated, then it would effectively compete on a free market with real massages, such that their costs may be nearly identical, in which case the company may not profit at all. In other words, on a free market, the cost of causing a person to live in a virtual reality world (a world so believable that the laborer himself cannot distinguish it from the real world) may not be substantially less costly than actually living in the real world, so the profit base of such deception may be limited. In both cases, the laborer actually experiences a massage, whether that massage was generated in the real world or virtual reality. In other words, in both cases, the laborer successfully labored for the ability to experience a massage. Further, even if the company is able to profit from substituting a virtual reality experience for a real experience, it is not entirely clear that the company has stolen anything from the laborer, in that the laborer received exactly what he voluntarily labored for: the experience of a massage.

Thus, while the present plot may utilize the use of virtual reality to maintain a laborer's belief that his labor is not being stolen, by causing him to experience that in virtual reality which he pays to experience, a more preferred embodiment of the present plot will be described as follows. When a laborer is compensated by pleasurable experiences (either directly or indirectly, such as by receiving the means (e.g., money) to obtain those experiences), the deceiving employer must actually generate those experiences, such as via virtual reality, an endeavor that may be very costly. However, besides valuing experiences, many people value (and thus are willing to accept as all or partial compensation), a belief itself, where the belief itself provides a particular desirable feeling or experience.

Using the previously presented example in which a laborer regularly charges $100/hr for his labors but only $90/hr for a charity whose mission is to reduce hunger among children in Africa, he accepts in lieu of $10 the belief that he is helping African children, because it gives him a good feeling that he subjectively values. In the above massage example, the laborer must actually experience the massage (actually or believably virtually) in order to believe he has been compensated. (Or, at the very least, he must believe that he has experienced the massage, which, absent brain or memory altering technology (which is within the scope of the present invention) would seem to be a near impossible task unless he has actually experienced the massage, actually or virtually.) In contrast to the massage example, the laborer need not actually experience (e.g., witness) the feeding of African children to maintain his belief that he is helping them. In other words, it may be relatively easy to cause and maintain a laborer's belief, where the belief itself (and not necessarily the experience corresponding to the belief) has value to the laborer.

When a belief is closely tied to a corresponding experience, it may be difficult and costly (and perhaps impossible) to cause the belief in the absence of the experience. For example, it may be difficult for a 5-star restaurant to cause a patron to believe that he has just consumed and enjoyed a $150 prime rib dinner without actually (or virtually) providing the prime rib dinner for the patron to experience. Thus, the restaurant will find it difficult to get paid unless it actually provides the experience (virtually or actually) that it advertises. However, lots of beliefs (even very strongly held beliefs) are weakly tied or completely untied to a corresponding experience—e.g., observe conventional religions. For example, the belief in Heaven (and one's ability to enter Heaven after death) is very valuable to millions of people, where the belief itself is relatively easy to maintain because the belief need not be caused or supported by a corresponding experience or evidence attesting to its truth.

Thus, the Catholic church has been able to amass disgusting quantities of wealth by “selling,” for a Catholic's labor, time, and tithes, the belief that Heaven and Hell exist, and that the Catholic will proceed to Heaven after death. In other words, the mere belief—at least temporarily divorced from any corresponding experience—is sufficient compensation to those who transact with the Catholic church (or any other religion).

In the above examples, the belief portion of the compensation has value to the laborer if and until the laborer discovers the falsity of the belief, at which point the value of the belief portion is retroactively stolen. For example, an altruist who pays $10/month to a charity that claims to feed children in Africa receives the good feeling from the mere belief that the charity is, in fact, feeding children in Africa. If the “charity” actually pockets $5/month and uses the remaining $5/month to maintain the altruist's belief (e.g., by sending a fake photo of a “sponsored” child), and if the altruist dies believing the charity's claims without ever having reason to doubt them, it is not clear that the charity has stolen anything from the altruist. The altruist received exactly what she paid for: the good feeling from believing that she helped a child in need. However, should the altruist learn the truth at some point, then everything she received (i.e., the belief) by paying the charity is immediately and retroactively devalued to zero value, and the charity has thus stolen her contributions.

In the above example, the charity does not profit from the altruist's belief unless it deceives her. For example, one method of causing the altruist to believe that her $10 are feeding a child in Africa is to actually send $10 worth (perhaps less a disclosed, small administrative or advertising fee) of food to Africa. However, the charity may then not profit at all, or more than knowingly allowed by the altruist. The charity may only profit heavily by committing fraud—by deceiving the altruist into believing that it feeds children in Africa. Thus, the altruist's belief (that she is actually helping children in Africa) is false.

Thus, in a preferred embodiment of the present plot, Mr. Chase causes Eric to labor for a compensation that includes a belief portion—i.e., a belief that Eric values substantially for its own sake, and need not accompany a corresponding experience. Further, the belief is false. As a result, if Mr. Chase then sells Eric's labor on a free labor market, he may keep the difference between the market value and the monetary compensation actually paid to Eric, less the cost of causing and maintaining Eric's false belief. In a preferred embodiment, virtual reality is used to cause and maintain Eric's false belief, because the cost of causing and maintaining Eric's false belief in virtual reality may be very low. In another preferred embodiment, Eric discovers that his belief is false. Therefore, the belief portion of his compensation is immediately and retroactively devalued to zero, so that Eric's net transaction with Mr. Chase causes Eric to labor for substantially less compensation than the market value of Eric's labor. If Mr. Chase paid Eric monetary compensation of 25% of $X (the monetary compensation Eric receives on the open market) and a belief portion comprising a false belief, once Eric learns or discovers that his belief is false, the only value he walks away with (i.e., his “take home pay” or his total actual compensation) is just his monetary compensation, or 25% of $X, which is substantially less than the market value of Eric's labor.

The word “enslaved” may be used herein to describe one who labors under the belief of threat of violence—i.e., one who believes that theft of his own body is involved. The word “enslaved” may be occasionally and more broadly used to describe one who labors under the conditions of set a)—i.e., under the belief that theft of something very valuable (such as one's child (“kidnapping”), one's reputation (“blackmail”), and so forth) is involved. In some cases, one whose child is kidnapped and taken for hostage is more easily manipulated (i.e., more “enslaved”) than one whose own body is taken for hostage. Alternatively, the word “captured” may be used herein to describe one who labors under the conditions of set b)—i.e., under the false belief that no theft (particularly of one's own labor) is involved.

Thus, Mr. Chase could offer as compensation any belief that Eric values. Any belief that humans value, as understood by one of ordinary skill in the art, is within the scope of the present invention. For example, Mr. Chase could be (or pretend to be) a religious official, and assert that Eric is helping to “save the souls” of the rest of the world or to convert the rest of the world to Christianity or Judaism or whatever. As another example, Mr. Chase could be (or pretend to be) a government official asserting that Eric is helping to alleviate some social problem or to prevent or retaliate against some security threat, and so forth. As another example, Mr. Chase could be (or pretend to be) an agent of a charity, asserting that Eric is helping to solve some social problem domestic or abroad, such as disease, hunger, overpopulation, environmental problems, and so forth.

In a preferred embodiment, Mr. Chase is or pretends to be a government official asserting that Eric is helping to stop or alleviate virtual-reality-induced slavery, because the audience may appreciate the irony that Mr. Chase has succeeded in capturing Eric and thus causing him to labor for substantially less than the market value of his labor. As discussed, capturing Eric is more beneficial to Mr. Chase than enslaving Eric, because Eric does not believe that theft is or will be involved, and diligently and happily labors in the absence of such a belief. (In this case, the “theft” ultimately deals with the theft of the belief portion of his compensation.)

In another preferred embodiment, instead of convincing Eric that millions of others have been enslaved by their virtual reality environments by the (false) belief that they are actually being physically threatened (or that other theft of something else, such as a child, is involved), Mr. Chase may instead convince Eric that millions of others have been caused to labor for substantially less than the market values of their labors by being captured—e.g., without having the belief of a physical threat or the belief that theft is involved. For example, Mr. Chase may expose to Eric the very means by which Eric is to be captured by the virtual reality—while causing Eric to believe that Eric is an exception (and is not being captured). This may occur while Eric still believes that he is in virtual reality, such as in his virtual office, described as follows. While Eric is in his virtual office, Mr. Chase may approach him in a virtual reality apparition, and explain to Eric the above described techniques of capturing.

For example, he may explain that a company may hire a person electronically, and while the person is hired, may release a virus in the information network to the person's virtual reality generating device (e.g., software and processor) that causes an alternate virtual reality that causes an apparition to appear to the person. The apparition explains to the person that he is a government official, a religious official, etc., and that he needs the person's help to solve some problem that the person is sympathetic to, as discussed, and offers as compensation a monetary compensation that is substantially less than a market value of the person's labor, as well as a belief (that happens to be false) that the person is helping to solve the problem. When the person agrees to help, the person's labor is freely sold on the open labor market while the apparition maintains the person's belief that he is helping to solve the problem. Because the cost of maintaining the person's belief by a virtual reality apparition is very inexpensive (it is included in the cost of the viral software used by the company), the company effectively profits by keeping the difference between the market value of the person's labor and the monetary compensation actually paid to the person. Thus, Mr. Chase needs Eric's help as a software engineer to help stop this problem, and “free” those who are currently captured by the viral software and the profiteering companies.

To this, Eric, who may be a software engineer, tells Mr. Chase that he agrees this would be a severe problem, but what evidence does Eric have that Mr. Chase is not a manifestation of the very viral software that he describes? “I could program a viral virtual reality even more believable than you,” Eric brags. “We know, and that's why we want you,” replies Mr. Chase. “If you don't believe, me, then log out.” Eric obeys and exits his virtual reality office, e.g., by turning off his virtual reality generating device. After he removes his head mounted display, because of the displays and/or speakers unknowingly mounted in his eyes and/or ears, he sees Mr. Chase sitting before him, and soon becomes convinced that Mr. Chase is a real person (not a virtual reality apparition) and that Mr. Chase is telling the truth about millions of others who are captured or enslaved by profiteering companies.

Soon, Eric freely and voluntarily agrees to work for Mr. Chase or for the cause explained by Mr. Chase. Perhaps Eric is somewhat intimidated by him, or perhaps Mr. Chase has made it clear that, now that Eric knows about the secret government project, he must work for it, and so forth. However, at least eventually, Eric must believe that his cause is worthwhile and valuable, causing Eric to labor under the conditions of set b) and not set a). An example of such a real-life psychological evolution is the use of the threat of physical violence to cause unwilling participants to labor in times of war—the draft. In a draft, the initial draftees are often very resistant to follow orders, believing that they have been enslaved by a person or group or cause which they do not support. However, over months of breaking down the draftees' psyche and brainwashing them with patriotism, the draftees often come to support the government and the cause, so that their labors soon become “voluntary,” with all the benefits that come with voluntary labor instead of slave labor. Eric's initial decision to labor for Mr. Chase for a monetary compensation less than a market value of Eric's labor may be based on a belief that theft is involved (e.g., slavery, intimidation, extortion, whatever) or not, and both are within the scope of the present invention, but in a preferred embodiment (although not necessarily), Eric eventually comes to value the belief or cause that he is laboring for, and thus his labors become more and more voluntary, happy, willing, and diligent.

Of course, Eric may be willing to work for no monetary compensation, where the belief portion of the compensation is more valuable to Eric than the market value of his labor. Further, while virtual reality (especially an electronically generated virtual reality) is used in a preferred embodiment to cause and maintain Eric's belief that he is helping to solve the problem posed by Mr. Chase, virtual reality is not necessary to cause or maintain a person's false belief. After all, governments (and, more particularly, specific government officials) have enormously profited over the centuries by causing and maintaining, without the benefit of virtual realities, the false belief among the general populous that governments are necessary for safety, security, stability, order, and so forth. Further, Christianity has also enormously profited over the centuries by causing and maintaining, without the benefit of virtual realities, the false (or at least not testable) belief among the general populous that Heaven is available to those who are “saved,” and that those who are “saved” can maintain their relationship with God by regularly attending and tithing the church.

Continuing with the preferred plot, Eric subsequently labors for a period of time, such as a few days, a few weeks, a few months, or a few years. Mr. Chase (an apparition, if not real) may or may not be Eric's direct “supervisor,” but in a preferred embodiment he is. During this time, Eric believes that he is working for Mr. Chase and furthering the worthwhile cause, which belief is valuable to Eric. In reality, Eric's labor is being sold on the open market, by the person, company, or entity (preferably a small company that actually invented and implemented the viral software, such as a company called “Labor Services, Inc.”) that captured Eric for a market value much greater than a monetary compensation (if any) actually paid to Eric. Labor Services may front as a labor union or other labor management company that represents its clients for a small fee. Further, Labor Services may sell Eric's labor anonymously, such as by assigning Eric a laborer number, or pseudonymously, such as by assigning Eric a different name, or neither.

When an entity needs a particular service or problem solved, it posts an employment request on the electronic bulletin board, previously discussed, requiring particular credentials (education, experience, and so forth) and may offer a particular price or price range for the services. Then, when Eric's labor is available for hire, his “resume” or other information is posted on the labor bulletin board, and a match is preferably automatically made, so that the entity agrees to pay Labor Services for the successful or acceptable solving of the problem or rendering of the requested service, and Labor Services then causes Eric to begin working the problem or rendering the service.

The virtual reality created by the viral software preferably causes Eric to never know that he is being bought and sold on the open labor market. For example, assume that an entity wants to hire a software programmer to create virtual reality software to mimic a typical child's playground. For example, the entity is trying to fill a market niche in which mothers or other caregivers can entertain a child by allowing the child to play in a playground, without actually having to take the child to a real playground. Preferably, the entity does not know that Labor Services sells captured or enslaved labor, and believes that Labor Services is a typical labor intermediary. When Labor Services fills this labor order by offering Eric's labor, Mr. Chase (or a supervising agent of Mr. Chase or Labor Services) appears before Eric (whether in Eric's virtual reality office, in which case Eric believes that Mr. Chase is a real person appearing as a virtual reality apparition, or as an apparition outside of his virtual reality office, in which case Eric believes that Mr. Chase is a real person really appearing before him). Mr. Chase causes Eric to fill the order while maintaining Eric's belief that Eric is working on the worthwhile cause. For example, Mr. Chase could tell Eric something like: “Eric, I've got a new, top secret project for you to work on. We have identified possible suspects of the companies that capture (or enslave) people. We need to enter their homes and take a look around . . . snoop around their desks and search their files. While they are in their virtual reality offices, they won't be able to see or hear us, but most of them have children who play in the house. It will be very difficult for us to enter and search the homes without the children noticing, so we need you to generate virtual reality software, representing a typical playground, that the children will be happy using and playing in.”

Then, Eric, still believing that he is laboring for the worthwhile cause, labors to invent and write the software that is ultimately delivered by Labor Services to the customer entity for the full market value of Eric's labor. Eric receives 25% (or some other small fraction) monetary compensation, a hearty “thanks” and/or “congratulations,” and the maintenance of his belief that he is helping Mr. Chase (or the government or a church, etc.) pursue a worthy cause. When the project is finished, Labor Services may again fill another labor order on the labor market with Eric's labor. Again, Mr. Chase (or another supervising agent) tells Eric (whether or not Eric believes that he is in virtual reality) something like: “We've got another project for you. This one deals with helping to catch and stop the capturers (or enslavers) in the following way . . . ” And so forth. Eric believes he is laboring for one continuous “cause” and one continuous “employer,” and has no reason to believe that his labor is being sold on the open market for approximately its market value.

Further, Eric may occasionally need help on his various projects. In this free labor market of the future, it may be common and acceptable for one laborer to hire another laborer for specific projects. Thus, if in performing the requested task or in solving the particular problem, Eric runs into an aspect for which another engineer or professional is better suited, he is free to hire another employee or laborer. Again, the name of the actually hired laborer may be absent, it may be replaced by a number or a false name, etc.

In furthering the present plot according to a preferred embodiment, Eric regularly hires other laborers to perform various tasks. Mr. Chase indicates that he has no problem with this, so long as Eric maintains the secrecy of the government project. One day, while Eric is working on a project for Mr. Chase (which has actually been requested by an independent customer entity, or Entity X), he stumbles on a relatively easy-to-perform task which would be better performed by someone else, to allow Eric to work on other aspects of the problem, so Eric puts out a labor order on the labor bulletin board. However, Eric's order is too specific, and much like a Boolean search that comes back with zero results because of too many “and” operations, Eric's order is not immediately filled. Of course, Eric, himself, is sufficiently qualified to match the labor order, and thus satisfies the labor order. Around the same time, Entity X, which had employed Eric via Labor Services, decides to terminate Eric's employment, for one of many possible reasons that would be understood by one of ordinary skill in the art, all of which are within the scope of the present invention (e.g., Entity X lost a customer which Eric's labor was to serve, or Entity X was unhappy with his performance or work product, or Entity X became bankrupt, etc.). Possibly due to a glitch in the labor market exchanging software, Eric's outstanding labor order did not immediately disappear or cancel upon his termination, so upon his termination, Eric's labor filled Eric's own labor order.

The next few scenes may show how Eric discovers that he has accidentally “purchased himself” or “hired himself.” For example, when he has not yet received the final work product which he had initially requested of the laborer who filled the labor order, Eric may send a friendly reminder to the laborer. Substantially simultaneously or a short time later, Eric's supervisor (who may be Mr. Chase) may then approach him in Eric's virtual reality office and express to Eric the urgency and importance of this project, and that Eric must finish the project very soon. Eric replies that he just contacted his employee, and that he expects the project to be finished soon. This transaction may substantially repeat itself, when Eric finally decides to just solve the problem himself, at which point he gives the work product to his supervisor. Substantially simultaneously or a short time later, Eric “receives” the requested work product from his employee. When the work product is identical to the one he just gave to his supervisor, Eric becomes suspicious, thinking at first that there was a glitch in the virtual reality software, or that it was a silly practical joke being played by his supervisor or Mr. Chase.

Eric then tries various things, such as commanding his employee to compose a limerick. Sure enough, his supervisor soon enters his virtual office, giving Eric some wacky but consistent story about desperately needing a limerick in their pursuit of the worthy cause. There are lots of silly, unusual, or otherwise unnecessary commands that Eric could promulgate, each command followed by a corresponding command from his supervisor, explained somewhat believably in the context of pursuing the worthy cause. Soon, Eric realizes that he, himself, fulfilled his own labor order, and that he is caught in a labor circle of being both employer and employed, simultaneously. He also realizes that such an event could only have happened if his labor had been traded on the labor market the entire time, and therefore that he had been fooled into falsely believing that he was pursuing some worthy cause for Mr. Chase.

Of course, Eric is now upset, disillusioned, stunned, and possible scared. He immediately logs out or exits from his virtual reality office and removes his head mounted display, if wearing one. He realizes that he has labored for some time now with little or no compensation, and now the pieces all fall into place: how many people did Mr. Chase (or, if Mr. Chase is only a virtual reality apparition, the company who infected Eric's virtual reality generating device with the viral software) capture by this method of causing and maintaining false beliefs? Eric wanders outside, still stunned, looking at the people passing by and wondering how many of them are currently captured.

Meanwhile, a person who actually works at Labor Services (e.g., one of the partners or owners of Labor Services who receives a portion of the profit made by selling the labor of captured laborers) is monitoring the various pyramid relationships between the laborers it has captured and other (if any) non-captured laborers. For example, in one embodiment, a captured first laborer's labor is sold to an independent entity by Labor Services. While working for the entity, the first laborer employs two second laborers, A and B, where laborer B is one of Labor Services captured laborers. Laborer B employs four third laborers, three of which are Labor Services captured laborers. In a preferred embodiment, only Labor Services knows that the captured laborers are captured. The remaining non-captured laborers may represent themselves (e.g., a future form of consultant), or may be represented by a trade union or other intermediary. These relationships result in a pyramid, with the first laborer at the top, the two second laborers A and B connected to and located under the first laborer, and the four third laborers connected to and located under laborer B. The worker at Labor Services monitors these relationships, so that at any given time she knows who works for whom, and which laborers are captured.

A short time after Eric accidentally hired his own labor, the worker notices something odd: Eric's identification (which may be identified on the worker's computer screen by Eric's real name, a false name, a number, etc.) appears on the screen, and then appears again, this time connected to the first appearance, and then appears again, connected to the second appearance, and then appears again, connected to the third appearance, and so forth. In other words, the computer was displaying an infinite loop: Eric the “employer” employed Eric the “employee,” but Eric the employee is an employer who employed Eric the employee, and so forth. Alternatively, two Eric identifiers could appear on the worker's screen, showing circular arrows connecting them, or a single identifier could appear on the screen, with an indication of “self-employed” or “error” or some other indication to the worker that Eric accidentally bought his own labor in the labor market.

The worker quickly realizes that Eric accidentally bought his own labor in the labor market, and thus has accidentally “broken free” from the system. The worker also realizes that Eric may now know of the system, and how he has been deceived into falsely believing that he was laboring for a worthy cause. The worker understands that Eric is a danger to the establishment—Labor Services' capturing and exploitation methods—because he probably knows the truth, and his likely resentment provides a strong motivation to expose the truth. The worker informs the owner or CEO or head of Labor Services, and the conflict of the plot begins. In one embodiment, the head of Labor Services is actually Mr. Chase. The apparition of Mr. Chase in Eric's virtual reality may actually represent Mr. Chase, or it may be a software-generated animation based on Mr. Chase's appearance, voice, etc. Or, if Mr. Chase was just the person who convinced Eric to labor for the worthy cause, while Eric's government (or religious, etc.) “supervisor” was someone else, Mr. Chase may be a real person whose apparition appeared in Eric's virtual reality. For the remaining description, it will be assumed that a real Mr. Chase is Labor Services head.

In one embodiment, Mr. Chase attempts to silence, eliminate, or kill Eric, to prevent him from exposing the truth and shutting Labor Services down. The plot may include a typical, action-packed Hollywood chase in which Mr. Chase and/or his agents hunt down and attempt to kill Eric. Alternatively or in addition, Mr. Chase and/or his agents take advantage of the virtual reality generating displays and speakers in Eric's eyes and ears to kill Eric while making it look like an accident or suicide, an example of which follows.

When Mr. Chase discovers that Eric knows the (at least partial) truth, Eric is wandering, disillusioned and perhaps drunk, down a city street, on a sidewalk adjacent to fast-moving traffic. In an embodiment in which the displays in Eric's eyes also include video cameras that transmit live video to Mr. Chase and/or his agents, Mr. Chase can see what Eric sees, and notices that Eric is walking beside a dangerous, high-traffic road. Thus, Mr. Chase or his agent could generate a partial virtual reality of the appearance (and preferably sound) of a large, dangerous, ferocious dog running or jumping toward Eric in a direction toward the road, causing Eric to jump back into the road and to be in harm's way. Alternatively or in addition, Mr. Chase or his agent could “shift” Eric's reality by an increasingly large vector, so that Eric eventually perceives himself to be in a very different location (such as a few feet away) from where he actually is. Thus, where he previously walked 20 feet away from the road, he now walks directly adjacent to the road, while still perceiving himself walking 20 feet away from the road. Thus, when something startles Eric, causing him to jump five feet to the right, Eric believes he is nowhere close to the road (and thus safe), while in reality he has jumped 5 feet into the road into oncoming traffic. Such may appear to be a suicide or accident. Mr. Chase could create any complete or partial virtual reality for Eric that causes Eric to move in a dangerous or fatal way, as understood by one of ordinary skill in the art, and all such ways are within the scope of the present invention. As another example (and there are thousands of similar examples), Eric may be walking across a bridge having only a small wall, and Mr. Chase could generate a partial virtual reality showing a platform laterally extending from the side of the bridge, and showing at the end of the platform an attractive woman, or a young man who appears to be ready to commit suicide, or a trapped puppy, or whatever. As Eric climbs over the bridge wall, he falls, thus appearing as a suicide. Of course, there are lots of ways to manipulate a person and cause that person to accidentally hurt or kill himself via the ability to generate complete or partial virtual realities to that person.

In a preferred embodiment, Eric does not die, and in fact is able to learn from the experience that his perceived reality is not real or at least alterable. For example, furthering the above mentioned example in which Mr. Chase causes Eric to jump in front of speeding traffic, assume that the traffic successfully avoids him, causing a massive car pile-up. Of course, Eric, who perceives himself at least 15 feet away, observes the accident, but is thoroughly confused because there does not appear to him anything in the traffic's way that caused the drivers to slam on their brakes. He sees a man (e.g., in one of the front cars) emerge and shout (apparently to the air) something like: “Are you OK? Hello? Are you hurt? Damn drunk!”

Soon, it hits him: the realization that Eric is, himself, standing in the middle of the road, and the object of the driver's inquiries, despite his observation that he is standing on the side and away from the road. He tests the theory by speaking at a voice at which the driver would not ordinarily have been able to hear him from his perceived distance from the accident. “Can you hear me?” he asks. The driver (who, again, is facing the middle of the road, not toward the direction that Eric perceives himself), replies, “Of course. What's wrong with you?” There may, of course, be more conversation further convincing Eric that, somehow, someone has control of his perceptions and is generating a virtual reality for him, and more importantly is trying to kill him. Of course, Mr. Chase and/or his agents also now realize that Eric has not been killed by the attempt, and now likely knows the truth that Eric's perceptions are readily changeable via a forced virtual reality. His goal is now to thoroughly confuse Eric so as to prevent him from escaping the wrath of the agents who are now hunting him down.

Alternatively or in addition, Mr. Chase's apparition may then approach Eric, laughing and asserting: “Joke's on you, Eric! The guys in the office wanted to play a little prank. Be a good sport. Come with me, Eric.” Eric, who is not so easily convinced, pretends to believe Mr. Chase, and extends his hand. “No hard feelings,” he says. Mr. Chase refuses to shake his hand, and Eric shakes his head. “You aren't real.” Mr. Chase points a gun at Eric and commands him to obey, but Eric continues uttering that Mr. Chase is not real. Of course, Eric is correct, and Mr. Chase disappears.

Eric has a friend, who was probably introduced earlier in the plot. Eric closes his eyes, realizing that his senses are useless to him at this point, and calls out to the driver that he is helpless, that he has $40 in his pocket, and can the driver please take him to his friend's house, whose address is . . . . When Eric arrives at his friend's house, Mr. Chase's agents are well on their way to the friend's house, and another of Mr. Chase's agents (e.g., a software programmer) is manipulating Eric's virtual reality to try to convince Eric that his friend doesn't believe him and wants him to leave his home. “You're crazy,” Eric perceives his friend saying, “There is no conspiracy to manipulate your reality. Are you drunk? Get out of my house and come back when you're sober!!” Luckily, at least in one embodiment, Eric does not believe his senses, and knows that his friend is treating him differently. Using good cinematography, the scenes may artistically switch back and forth between the scene as perceived by Eric and the scene as it is really occurring.

Eric carefully explains to his friend what has happened, and his friend, who may also be a software engineer or at least very knowledgeable about virtual reality and its implementations, looks into Eric's eyes and sees two small spots which the friend identifies as permanently impregnated virtual reality displays. He may then call a medical doctor friend, who comes over and removes the displays and/or speakers, or the friend may attempt to do it himself. Eric soon sees the real world again, and knows that he, his friend, and possibly the doctor must leave immediately.

The chase continues. Eric and his friend grab a laptop computer and run for a car, at which point they speed away, just moments before Mr. Chase's agents show up and open machine gun fire on Eric's friend's house. Eventually, Eric and his friend temporarily find a safe hideout, where they remain for several minutes, hours, or days until Eric has written new software, the purpose of which may not yet be disclosed to the audience. Meanwhile, Mr. Chase is becoming desperate, and soon feels the jaws of defeat as his agents lost Eric's trail, and Mr. Chase realizes that Eric may now be free to expose the system/method, Labor Services, and Mr. Chase himself.

In the depths of Mr. Chase's resignation, he notices on his computer screen that Eric has just logged in to the system, and thus has “checked in” to work. Of course, Mr. Chase is stunned, but realizes that Eric must be at home to have voluntarily entered virtual reality, so Mr. Chase radios or calls or signals to his machine gun armed agents to proceed immediately to Eric's home. Mr. Chase then curiously enters the virtual reality office to meet with Eric. Eric (or, as will later be discovered, a virtual reality generated apparition of Eric) tells Mr. Chase that he knows everything, and that he is willing and ready to expose the method, Labor Services, and Mr. Chase to the authorities (e.g., police) unless Mr. Chase is willing to split Labor Services' profits with Eric (or at least give Eric a large amount of money). Mr. Chase pretends to consider the offer, while asking Eric many questions (or dragging out the conversation) so as to stall Eric as Mr. Chase's agents arrive at Eric's home.

A moment later, Eric's apparition turns around and says, “What the hell?. . . ” Mr. Chase smiles and says, “I've given it lots of thought, Eric, and I'm sorry to tell you that I reject your offer.” Eric's apparition disappears from Mr. Chase's virtual reality, and Mr. Chase smiles and exits his virtual reality office, believing that Eric has been killed by his agents. It should also be noted that Mr. Chase, who readily enters and exits his virtual reality office, may voluntarily wear a pair of removable “virtual reality display contacts” on the surface of his eyeballs and a pair of removable “virtual reality speaker headphones” within his ears. He may also wear video cameras and/or microphones in these small removable devices. Also, Mr. Chase, who does not yet know that he has been the object of a lie, also does not know that his network connection with Eric's virtual reality office allowed Eric to upload a viral software (the software that he programmed while hiding out with his friend) to Mr. Chase's virtual reality generating device.

Mr. Chase then radios or calls his agents to congratulate them on a job well done, and one of the agents replies that they are just now entering Eric's house, at which point Mr. Chase realizes that he has been fooled by virtual reality. He turns around and sees Eric (or, what may later turn out to be another apparition of Eric, generated by a partial virtual reality induced by Mr. Chase's pre-mounted displays and speakers and the viral software previously uploaded by Eric), who holds a gun toward Mr. Chase. Of course, Mr. Chase has no reason to believe that Eric is an apparition. Eric demands that Mr. Chase free all of his captured laborers, and that he pay Eric all of Mr. Chase's wealth or money. Mr. Chase absolutely refuses, saying that Labor Services has represented his life work, and that he would rather die than to give up both his money and Labor Services. Eric strikes a deal with him: release all of the captured laborers, and pay Eric a mere 10% (or some other small percentage or relatively small quantity of money, such as $1M of Mr. Chase's tens of hundreds of millions of dollars). In return, Eric will give Mr. Chase time to leave the country and to get lost in an anonymous place, where Mr. Chase can enjoy his wealth and the memory of how he obtained it.

Reluctantly, realizing that his options are limited, Mr. Chase agrees. He first “fires” each and every of his captured laborers, such as by hitting a few keystrokes on his computer. (Alternatively or in addition, Eric may force Mr. Chase to appear as a virtual reality apparition before each of the captured laborers and either or both of: explain exactly what he did and how he did it; and apologize or assert how terrible and cruel a man he is.) Then, Mr. Chase logs into his bank account on his computer, being sure to block Eric's view from seeing Mr. Chase enter his banking password (but not realizing that the real Eric is watching and recording every one of Mr. Chase's keystrokes through Mr. Chase's own eyes, as sensed by the video cameras in Mr. Chase's “contacts”). Mr. Chase then transfers the agreed upon amount to an account indicated by Eric. Once finished, Eric says, “Thank you. It was good doing business with you,” and extends his hand. Mr. Chase cautiously extends his hand, only to see his hand pass right through Eric's; Eric is a virtual reality generated apparition! “No!” cries Mr. Chase as he turns around to look at his bank account balance on the computer screen. But it is too late. The real Eric, interacting with Mr. Chase's virtual reality from a remote location (such as from the hideout in which he programmed the viral software), has already transferred the remaining of Mr. Chase's account balance to Eric's own account, based on the password which he recorded when Mr. Chase logged into his own account.

At this point, police (who clearly were referred by Eric) may arrive at Mr. Chase's real office and arrest Mr. Chase, or Mr. Chase, who now has lost everything he has worked for, may kill himself, or something else terrible may happen to Mr. Chase. The story may end with the freedom of everyone who was previously captured, and with Eric pursuing some dream that he always had (which may have been disclosed earlier in the movie), and may be lying under the hot St. Thomas sun, sipping a margarita, and wondering how he will spend his millions.

There are very many possible embodiments of the present plot. The above described version has been described as broad as possibly, while maintaining true to the specific embodiment given. However, many variations are within the scope of the present invention. For example, an electronically generated virtual reality need not be used at all. Eric may simply be approached by a convincing “con artist” who causes Eric to work for the con artist for a monetary compensation substantially less than the market value of Eric's labor, where the con artist convinces Eric that he is needed for a worthy cause which Eric values. Buying and selling of labor may still occur on a fast electronic network, but with less sophistication than described previously (in fact, a sophistication that is clearly available with current technology). When Eric accidentally purchases his own labor, a real person (his “supervisor”) may give Eric a call or show up at Eric's office and “translate” the “employer's” (Eric's own) command into a command that is consistent with the worthy cause for which Eric labors. Thus, the event in which Eric discovers that he has purchased his own labor on the open labor market, and that he is really not laboring for the worthy cause, may occur as Eric “commands” his “employee” over, e.g., e-mail, with corresponding and subsequent calls from his supervisor commanding similar things. When Eric finally sends an email to his “employee” to compose a silly limerick, and his supervisor immediately calls up Eric and requests that Eric do the same thing (but in the context of furthering the worthy cause), Eric then realizes the truth and how the system works.

A theme of the plot of the present invention may be that people often labor in whole or part for beliefs that may actually be false. A person who labors for a body massage loses less (if anything) when he discovers that the massage resulted from virtual reality generated sensations—i.e., the belief that the person actually received a massage from a human masseuse (which belief is false) may be far less valuable (and in fact may have no value) than the belief that he experienced a massage, which belief is true whether or not the massage was really performed by a human masseuse. In contrast, a person who labors for a belief loses more (if not everything) when he discovers that the belief is false. The plot may have thematic overtones that are critical of religion, government, and other institutions which rely upon (and profit from) propaganda and perpetuation of belief.

While the present plot need not rely on the use or extensive use of virtual reality technology, virtual reality may make the plot more interesting, more believable, and may show how easily and cheaply a person may be caused to believe and continue to believe a belief valuable to that person.

Further, the protagonist need not discover that he has been “captured” by purchasing his own labor. Other methods are within the scope of the present invention. For example, he may be conversing with a friend, who may also be captured, when in spite of their order to maintain the secrecy of the government mission, the conversation slowly and cautiously evolves toward the truth, as understood by one of ordinary skill in the art. In another embodiment, Eric's suspicion may be raised when he is asked to perform two subsequent tasks which are phonetically similar or written similarly, where the first one is quite wacky. For example, Eric's labor may have been sold/rented to a company that writes and sells flight simulator virtual reality software, and may have provided instructions to Labor Services via email (or other written communication) that mistakenly request “virtual reality software that causes the person to believe that he is frying,” instead of “flying.” Of course, Eric's apparition supervisor gives Eric the order, explaining in some elaborate but not-so-believable story why the government wants one of the enslaving entities to experience being “fried.” Once the company recognizes its error, it sends a revised order requesting “virtual reality software that causes the person to believe that he is flying.” While Eric is in mid-project on the suspicious “frying” project, his supervisor explains that the previous project has been canceled, and a new “virtual reality flying” project is to be performed. Eric notices the similarity between the two projects, and realizes that his supervisor, if a real person who is intimately involved with a secret government project, would not have confused the words “flying” and “frying.” (Similar word mix-ups may provide for comic relief.)

This may cause Eric to begin snooping around, such as secretly contacting various flight simulator virtual reality software programmers. Using various investigation techniques, Eric (or a hired investigator) eventually discover that Eric currently “works” for a particular company, which has nothing to do with the government. For example, Eric could pretend to be a wealthy customer and could “hire” the company to write some kind of weird, particular software. When Eric is subsequently assigned to write such software by his supervisor, he discovers the truth.

Further, in another embodiment, Eric is completely captured by his own virtual reality generating device, such as by one of the methods previously discussed (e.g., the method described by Mr. Chase to Eric), in which case the plot need not call for virtual reality displays and/or speakers being permanently mounted in his eyes and/or ears. For example, it may be common for people to wear removable virtual reality generating devices on a regular basis, so that the viral software may be designed to cause Eric to believe that he has exited virtual reality, while in fact remaining in it (at least partially).

Another means for causing a person to believe that he has successfully exited virtual reality (and thus is sensing only actual reality) may be as follows.

In the case of a virtual reality generating device that only displays images and generates sounds, a user of the virtual reality understands that nothing “touched” in virtual reality will be felt. Thus, when Eric is working in his virtual reality office, an agent of Mr. Chase quietly enters into Eric's home and implants a robotic device in Eric's actual room that can extend to touch or strike Eric in various places. Then, while Eric is in his virtual reality office speaking to Mr. Chase, and Eric expresses his disbelief that Mr. Chase is real or anything more than a virus, Mr. Chase slaps Eric's face or shakes his hand or touches Eric in some other way. Then, the robot actually touches Eric in a corresponding way, to convince Eric that Mr. Chase is real (or at least that Eric is not completely in virtual reality), because Eric believes that he cannot feel any tactile sensations in his virtual reality office. The robot may then be removed from Eric's office; alternatively, a real person may touch Eric in the way corresponding to Mr. Chase's touches. Such a method may also be used to enslave Eric, if the plot calls for enslaving (e.g., based on the belief that theft is involved), or to enslave others, or may be explained by Mr. Chase as the method by which the “evil” profiteering companies enslave others, and so forth. For example, the virtual reality apparition may punch other otherwise abuse the person, and the person may receive corresponding actual abuse by a robot or real person while the person is in the virtual reality environment.

Of course, as discussed, Eric may be enslaved or caused to labor based on the belief that theft is involved (e.g., a belief in a kidnapping, extortion, and so forth), but preferably is captured based on no belief that theft is involved (e.g., deceit based on false information provided in virtual reality), so that he is willing and happy to labor for a relatively long time, so long as his beliefs are maintained.

In another embodiment, in the ultimate kind of irony, Mr. Chase himself is captured or enslaved in the end. For example, when Eric (or his apparition) appear in Mr. Chase's office near the end of the plot, Eric may offer to keep Mr. Chase's secret in exchange for being a partner in the business. Eric tells Mr. Chase that he may remain an owner and/or partner, but that he must retire and let Eric take over the business, and Mr. Chase will no longer receive any more profits. Eric then explains that Mr. Chase will occasionally be called back to help out when help is needed, but that Mr. Chase should just enjoy his retirement and spend his money. Mr. Chase agrees, possibly excited by the opportunity to retire and/or move onto something else, while being retained sufficiently to help maintain the business that he invented and developed. After all, many people return to a business (especially a self-made business) from retirement—not for the profit—but because of the love of the business and the belief that the business is being successfully maintained. As may be true with Mr. Chase.

Then, Eric may shut down the business by exposing the truth to the captured laborers, but retain Mr. Chase as a captured laborer who helps Eric out on various difficult projects. For example, after shutting down the business and freeing the captured laborers, Eric may again enter private business as a laborer for hire. He is able to do twice the labor, particularly very difficult and lucrative projects, because he occasionally meets Mr. Chase in his virtual reality office and tells a false story about how working on a particular project (for which Eric is being paid to perform in the free labor market) is necessary to the continued success of Labor Services. Mr. Chase happily helps out, and lives happily on his savings and on the compensation provided by Eric: the belief (which is very valuable to Mr. Chase) that Mr. Chase's business successfully lives on. Thus Mr. Chase is captured and thus labors for a false belief. Perhaps Mr. Chase is disposed to be suspicious of the situation, but so badly wants to maintain his belief that his business is being continued, that he is willing to suspend any disbelief—in much the same manner that very devout Christians are likely to ignore evidence against the truth of Christianity. In other words, the belief is so valuable to Mr. Chase that he is willing to take the risk that he has been captured in order to maintain the belief. The movie may end at this point, with Mr. Chase blissfully ignorant and Eric enjoyed his increased success and his sweet, ironic revenge, and/or Mr. Chase may eventually discover the truth.

Alternatively or in addition, Eric may not shut down the business at all; he may continue running it, with Mr. Chase the best, most intelligent, and most productive of the captured laborers. Such an ending is not the conventional happy ending in which the world's evils are solved; rather it is a deeper, perhaps more thought-provoking, more cynical ending, causing the audience to wonder if they are perhaps laboring for false beliefs that are caused and maintained by deceitful profiteers.

“Monetary compensation” may refer to that portion of a compensation comprising a common currency or other readily exchangeable medium of exchange, as understood by one of ordinary skill in the art, including but not limited to cash, check, credit, gold, silver, platinum, diamond, any other precious metal or gem, real estate, stocks, bonds, and any other readily exchangeable property rights.

Many variations on this plot are possible. For example, in the variation in which Eric and/or other laborers are enslaved by one or more apparitions created in their virtual reality environment, the plot may be more believable if interaction by friends or loved ones in prevented. For example, if a dictator apparition convinced Eric that his life was being threatened, then Eric may be willing to labor under slavery for a relatively short amount of time before he emotionally breaks down—e.g., cries in the actual presence of friends or loved ones. When this occurs, of course, Eric may soon discover that the slavery was induced by virtual reality, and that perhaps no real threat exists, in which case Eric will not continue to labor under slavery.

To prevent this, Labor Services (if they utilize slavery or those conditions under set a)) may select potential slaves who are already hermits or do not have many close family members or friends, and the dictator apparition may command that the potential slave does not do anything while outside of virtual reality except to eat, sleep, and go to the bathroom—i.e., may command that the person does not go outside or contact anyone, for the threat that the dictator or his agents are watching and will kill or torture the person at any time if he disobeys the command. Of course, the virtual reality here succeeds in profiting Labor Services (or the owner) because the cost of actually enslaving someone by having one or several armed guards constantly watching and threatening the slave may be prohibitive, and would be far more costly than generating such an appearance in virtual reality. The dictator may also command that, should anyone try to contact the person, he must ignore the contacts, and/or kill himself before contact is made. Labor Services or the slave owner must then be responsible for paying the slave's bills, having food delivered to his home, and so forth.

In addition or alternatively, Labor Services may have sought out potential slaves who recently moved, to make tracking down the slave very difficult, even for family members. Further, right after the potential slave moved, Labor Services may contact the person's friends and family and indicate that the person has just joined the Peace Corps (or military, or secret government project, or whatever), and will not be able to be contacted for a few years. Or, Labor Services may cause the person's friends and family to become very unhappy or angry with the person, in ways apparent to one of ordinary skill in the art, such as writing fake letters on the person's behalf, or sending doctored pictures to the person's wife or girlfriend of the person with another woman, and so forth. Thus, his friends and family are unlikely to then try to contact the person.

The slavery may last a lifetime, or only a few years, after which the slave is killed (e.g., made to look like a suicide or natural death), or at least warned never to speak of the slavery for the rest of his life, at the threat of torture or death.

In another embodiment, Labor Services may have a different name, such as Animated Laborers, Inc., and may pretend to sell software that emulates the work or labor of actual humans, because the software is so advanced and mature. Each “software package” may include a computer chip or network connection password that links the software purchaser to a corresponding slave. Thus, all the owner needs to do is type in or otherwise electronically enter the desired task into the processor executing the software, and the response (and finished work product) will be very human-like in style and intelligence. Of course, little do the owners know, Animated Laborers has merely enslaved or captured laborers (by any of the methods discussed or apparent variations), and linked laborers to corresponding sold computer chips or software. Such chips or software may then be available on the open labor market to compete with “actual” human labor (even though the chips represent actual human labor, unbeknownst to the rest of the populous), with Animated Laborers the monopoly producer of such chips, because only they (as they claim) know how to produce software so intelligent and advanced as to appear like human labor. The chips and/or software actually produced by Animated Laborers may only translate a command input (such as “analyze these demographics data for the sales of Product X and make recommendations regarding improvements or changes to the product or its advertising methods to increase sales”) into a corresponding command given to the captured person by his supervisor (and altered to reflect pursuit of the worthy cause), or to the enslaved person by the dictator (and altered to remind the slave of the remaining physical threat). Not only do owners and others in the general populous not suspect that their animated “software” laborers are real, enslaved or captured laborers, but they also don't seem to notice why they rarely if ever see their next-door neighbor (who may be enslaved), and so forth.

In another embodiment, Eric's virtual reality office may be programmable and almost completely controllable by him. For example, instead of a virtual reality cubicle, Eric may program a virtual reality office having a large desk overlooking a tropical paradise, with attractive people lying on a beach and catamarans sailing in the water. Eric may or may not be able to control the appearance or entrance of supervisors or co-workers, in spite of an ability to adjust the other ambiance to his taste.

In another embodiment, particularly in the case where Eric is enslaved and he lives with his wife, Labor Services may use the displays in Eric's eyeballs to create a complete or partial virtual reality in which he catches his wife cheating on him (or sees his children run away or be killed, or his friend abandon him, etc.). Thus, Eric may be likely to leave his wife and find his own residence, where Eric may then more easily be controlled and enslaved, as the likelihood that a loved one then “reads his face” (in spite of Eric's obedience to remain silent about the slavery) is far less.

In another embodiment, Labor Services may utilize its ability to generate complete or partial virtual realities for Eric to pay Eric less monetary compensation than the market value of his labor. For example, Mr. Chase could convince Eric to work for him for a compensation that appears to include a new Ferrari. Perhaps Eric is willing to work a year for the Ferrari alone (in which case the Ferrari is monetary compensation that is not substantially less than the market value of Eric's labor). Labor Services could then purchase a Ford automobile for Eric, and program Eric's virtual reality displays in his eyeballs to display the image of a Ferrari every time Eric looks at his Ford. Labor Services then profits by retaining the difference in cost between the Ferrari and the Ford.

In another embodiment, people may regularly spend most of their time in virtual reality, to work, play, live, and so forth, possibly (but not necessarily) needing to exit virtual reality only to eat, sleep, have sex, and so forth, because the cost of pursuing one's desires in virtual reality may be far less costly than actually doing so in the real world. Further, most people may look, in the real world, far different (probably worse, such as fatter, paler, etc.) than they appear in virtual reality, as most or all of a person's social transactions may occur in the virtual reality environment.

Further, in another embodiment, people may regularly wear virtual reality displays in their eyes (like contacts) and speakers in their ears, removable only if the displays and/or speakers malfunction, if the processor gets infected with a virus, or if the wearer no longer wants to experience virtual reality. If true, then Eric may already wear such a virtual reality generating device when it is infected with the viral software according to any of the embodiments described above, and Eric need not necessarily be drugged or gassed to allow the “bad guys” to surgically implant the displays and/or speakers in his eyeballs and/or ears. Here, the apparition of Mr. Chase is so convincing (or Labor Services uses another method of convincing Eric, such as allowing Mr. Chase to “touch” Eric by using a robotic arm placed in Eric's room, as previously discussed) that Eric doesn't initially believe that Mr. Chase is a virtual reality apparition. In another embodiment, Labor Services simply steals Eric's actual wealth from his bank account by obtaining his password (via the cameras implanted in Eric's eyeballs) when Eric electronically logs into his bank account. Then, by “painting” a partial virtual reality every time in the future that Eric looks at his bank statement online, Labor Services can make the account balance appear “correct” (i.e., what the account balance should be, without the theft by Labor Services). As long as Eric saves over many years without spending much (which could be artificially encouraged by Mr. Chase or another person or apparition “offering” a great, high-interest savings plan), Labor Services can effectively take most or all of this wealth while causing Eric to believe that nothing has been stolen. Further, Mr. Chase could cause Eric to believe that Eric has, in fact, always been working for the secret government mission (or the appropriate worthy cause), but only now the cause is being exposed to Eric because the government has run out of money with which to pay Eric (and other similar laborers, if any). Eric is asked to continue to work as he previously has, while being willing to accept a large pay cut to further the worthy cause. Then, Mr. Chase or his agents or Labor Services could just regularly steal from Eric's bank account while Eric happily and voluntarily works for the worthy cause.

The storyline may include an indication that Mr. Chase intends to cause Eric to indefinitely believe that Eric will be compensated as promised. Eric's compensation may include a monetary portion (which may be zero) and a belief, which may be false. Mr. Chase may know the belief to be false, and Eric may later discover that the belief is false. The storyline may also include an indication that, while Eric receives his compensation having a monetary portion, his labor is being sold on a labor market for substantially more than the monetary portion.

For example, in the above described embodiment, Eric's virtual reality environment may be created by an electronic virtual reality generating device. However, other ways of creating virtual reality environments are within the scope of the present invention. For example, technology may be available far in the future to create virtual realities in one's head by altering one's brain (e.g., using electromagnetic waves or other known “sci-fi forces”), without the necessity for 3-D head-mounted displays and headphones, etc. Conversely, similarly exotic technology may be used to extract the relevant images/stimuli from Eric's head (for subsequent use by the virtual reality generating device) without the need for cameras, microphones, and/or other sensors. As another example, a virtual reality may be created by, e.g., physically constructing an appropriate setting and utilizing human actors/actresses to act in ways that simulate a reality for the user. See, e.g., The Truman Show and The Game, the plots of which is herein incorporated by reference. Similarly, information regarding Eric's life may be gleaned by inquiry (such as by a trained psychologist) instead of cameras, microphones, etc.

Dynamic characters make interesting plots. At least one of the characters, preferably the protagonist, is dynamic. For example, Eric may have previously believed, as indicated by Eric's own words or actions, that lying or deceiving a person to accomplish a selfish task was allowable or moral, as long as it didn't hurt the other person, or as long as the other person didn't know. Eric may learn his lesson when he finally learns how difficult it is to maintain a person's false belief—therefore, those he previously deceived may have ultimately discovered the truth, in which case they have been stolen from.

In a preferred embodiment, several features are indicated, such as the protagonist's having a false belief, and the protagonist's belief (near the beginning of the plot) that he is not in the virtual reality environment when in fact he is. As well known by those of ordinary skill in the art, there are many ways to indicate a fact in a movie without any explicit words to that effect at all: circumstance, cinematography, subtly suggestive newspaper headlines, suggestive words by the protagonist or other characters, etc., can all be indicative of that fact.

The story preferably has a timeline, which will be well understood by one of ordinary skill in the art. For example, in a story containing flashbacks, the timeline may represent the chronological order in which events occur in the story. Therefore, a flashback may occur earlier in the story's timeline, even though the flashback is presented in a later part of the story.

The present invention applies to any practical application or use of the present plot. For example, the invention includes the processes of relaying a story having the present plot, writing a book having the present plot, printing a book having the present plot, creating a movie having the present plot, displaying or showing a movie having the present plot, filming a movie having the present plot, inciting actors to act out the present plot, creating an audio recording of a story having the present plot, etc. The present invention also applies to any product of any of these processes—e.g., a book containing written information of a story having the present plot, an audio tape or CD disk containing audio information of a story having the present plot, a VHS tape or DVD or VCD disk containing video information of a movie having the present plot, etc. The present invention may also include a product formed by any of the processes described, where the product is a VHS cassette, a DVD, a VCD, a book, etc.

For example, creating a movie having the present plot may include inciting an actor to act as the protagonist. As will be understood by one of ordinary skill in the art, a producer or director or production company may incite an actor to act as the protagonist by promising a financial or a career-related reward or advancement. Creating such a movie may also include providing a set, as known by those of ordinary skill in the art, video cameras (preferably high-resolution digital video cameras), and editing equipment, and using the set, cameras, and equipment to create video segments of footage of the actors acting consistent with the present plot. The final video may be stored on an information storage medium, duplicated onto VHS tapes or DVDs, and distributed and sold.

Finally, regarding a program product that comprises machine-readable program code for causing, when executed, a machine to perform process steps, the machine could be a VCR or DVD player or similar, and the code could comprise the instructions and/or data which, when read by the VCR or DVD player, causes the VCR or DVD player to perform the indicated process steps, whether directly or indirectly via a monitor (e.g., television screen) and speakers.

1. A process of relaying a story having a timeline and a unique plot involving characters, comprising:
indicating that a first character voluntarily enters a virtual reality;
indicating a belief by said first character that said first character is not in virtual reality; and
indicating that an interaction in virtual reality between said first character and a second character, while said first character has said belief, causes said first character to labor for, at most, a compensation substantially lower than a market value of said first character's labor.

2. The process as claimed in claim 1, wherein said interaction comprises said second character threatening said first character.

3. The process as claimed in claim 1, wherein said interaction comprises said second character deceiving said first character into believing that said first character will labor for at least one of an false entity, a false price, and a false cause substantially different from a corresponding one of an actual entity, an actual price, and an actual cause.

4. The process as claimed in claim 1, wherein said interaction comprises said second character indicating to said first character that said second character is a religious agent who desires labor from said first character to help further a worthy cause.

5. The process as claimed in claim 1, wherein said interaction comprises said second character indicating to said first character that said second character is a government agent who desires labor from said first character, and
wherein said interaction further comprises said second character indicating that said labor is desired from said first character to help fulfill a secret government mission to further a worthy cause.

6. The process as claimed in claim 5, wherein said worthy cause comprises combating an evil, said evil comprising a use of virtual reality to cause laborers to labor for, at most, compensations substantially lower than market values of their labors.

7. The process as claimed in claim 1, further comprising:
indicating that entities regularly buy and sell labor on a market; and
indicating that at least some of said labor is performed by laborers who labor for, at most, compensations substantially lower than market values of their labors.

8. The process as claimed in claim 7, further comprising indicating that the fact that at least some of said labor is performed by laborers who labor for, at most, compensations substantially lower than market values of their labors is not known to at least a majority of said entities.

9. The process as claimed in claim 1, further comprising:
indicating that entities regularly buy and sell labor on a market; and
indicating that at least some of said labor is performed by laborers who believe they labor for at least one of a false entity, a false price, and a false cause substantially different from a corresponding one of an actual entity, an actual price, and an actual cause.

10. The process as claimed in claim 9, further comprising indicating that a profiteer profits by selling said at least some of said labor performed by said laborers on a market and at least maintaining said laborers' beliefs that they labor for said at least one of a false entity, a false price, and a false cause.

11. The process as claimed in claim 10, further comprising indicating said profiteer becoming a captured laborer.

12. The process as claimed in claim 9, further comprising indicating that the fact that at least some of said labor is performed by laborers who believe they labor for said at least one of an false entity, a false price, and a false cause is not known to at least a majority of said entities.

13. The process as claimed in claim 9, further comprising indicating that said first character is one of said laborers.

14. The process as claimed in claim 13, further comprising indicating said first character learning that said first character is one of said laborers.

15. The process as claimed in claim 14, further comprising indicating said first character learning that said first character is one of said laborers at least in part by said first character accidentally purchasing said first character's own labor on said market.

16. The process as claimed in claim 1, wherein said process is a process of displaying a motion picture having a timeline and a unique plot, comprising:
displaying a video representation of an actor acting as said first character;
displaying a video representation of said actor indicating said first character voluntarily entering a virtual reality;
displaying a video representation of said actor indicating said belief by said first character that said first character is not in virtual reality; and
displaying a video representation of an indication that that an interaction in virtual reality between said first character and said second character, while said first character has said belief, causes said first character to labor for, at most, a compensation substantially lower than a market value of said first character's labor.

17. The process as claimed in claim 1, wherein said process is a process of creating a motion picture having a timeline and a unique plot, comprising:
providing a set;
providing a video camera configured to video at least a portion of said set;
inciting an actor to act as said first character;
inciting said actor to indicate said first character voluntarily entering a virtual reality;
creating a first video segment via said video camera by filming said indication of said first character voluntarily entering a virtual reality;
inciting said actor to indicate said belief;
creating a second video segment via a video camera by filming said indication of said belief by said actor;
inciting said actor to indicate engaging in said interaction;
creating a third video segment via a video camera by filming said indication of said engaging by said actor;
editing and combining at least part of at least said first, second, and third video segments to form a motion picture; and
storing said motion picture on an information storage medium.

18. A program product for relaying a story having a timeline and a unique plot involving characters, said product comprising machine-readable program code for causing, when executed, a machine to perform the process as claimed in claim 1.

19. A process as claimed in claim 1, further comprising:
indicating that entities regularly buy and sell labor on a market, the labor being at least one of substantially anonymous and substantially pseudonymous;
indicating that at least some of said labor is performed by captured laborers, wherein a captured laborer is one who: a) labors for, at most, a monetary compensation substantially lower than market values of his or her labor; and b) believes he or she labors for at least one of a false entity, a false price, and a false cause substantially different from a corresponding one of an actual entity, an actual price, and an actual cause;
indicating that said interaction causes said first character to become a captured laborer; and
indicating said first character learning that said first character is a captured laborer,
wherein the virtual reality is electronically generated.

20. A process of relaying a story having a timeline and a unique plot involving characters, comprising:
indicating that entities regularly buy and sell labor on a market;
indicating that at least some of said labor is performed by captured laborers, wherein a captured laborer is one who: a) labors for, at most, a monetary compensation substantially lower than a market value of his or her labor; and b) believes he or she labors for at least one of a false entity, a false price, and a false cause substantially different from a corresponding one of an actual entity, an actual price, and an actual cause;
indicating that an interaction between a first character and a second character causes said first character to become a captured laborer, wherein said interaction comprises said second character deceiving said first character into believing that said first character will labor for at least one of a false entity, a false price, and a false cause; and
indicating said first character learning that said first character is a captured laborer.

21. The process as claimed in claim 20, further comprising indicating that a profiteer profits by selling said at least some of said labor performed by said captured laborers on said market and at least maintaining said captured laborers' beliefs that they labor for said at least one of a false entity, a false price, and a false cause.

22. The process as claimed in claim 21, further comprising indicating said profiteer becoming a captured laborer.

23. The process as claimed in claim 20, further comprising indicating said first character learning that said first character is a captured laborer at least in part by said first character purchasing said first character's own labor on said market.

24. The process as claimed in claim 20, wherein said first character's belief that said first character will labor for said at least one of a false entity, a false price, and a false cause is at least one of caused and maintained by an electronically generated virtual reality.

25. The process as claimed in claim 20, wherein said interaction comprises said second character indicating to said first character that said second character is a religious agent who desires labor from said first character to help further a worthy cause.

26. The process as claimed in claim 20, wherein said interaction comprises said second character indicating to said first character that said second character is a government agent who desires labor from said first character, and
wherein said interaction further comprises said second character indicating that said labor is desired from said first character to help fulfill a secret government mission to further a worthy cause.

27. The process as claimed in claim 26, wherein said worthy cause comprises combating an evil, said evil comprising a use of virtual reality to cause laborers to labor for, at most, monetary compensations substantially lower than market values of their labors.

28. The process as claimed in claim 20, further comprising indicating that the fact that at least some of said labor is performed by captured laborers is not known to at least a majority of said entities.

29. The process as claimed in claim 20, further comprising indicating that said interaction occurs in an electronically generated virtual reality while said first character believes that said first character is not in virtual reality.

30. The process as claimed in claim 20, wherein said process is a process of displaying a motion picture having a timeline and a unique plot, comprising:
displaying a video representation of an indication that entities regularly buy and sell labor on a market;
displaying a video representation of an indication that at least some of said labor is performed by said captured laborers;
displaying a video representation of an indication that said interaction between said first character and said second character causes said first character to become a captured laborer; and
displaying a video representation of an indication of said first character learning that said first character is a captured laborer.

31. The process as claimed in claim 20, wherein said process is a process of creating a motion picture having a timeline and a unique plot, comprising:
providing a set;
providing a video camera configured to video at least a portion of said set;
inciting an actor to act as said first character;
inciting said actor to indicate engaging in said interaction;
creating a first video segment via a video camera by filming said indication of said engaging by said actor;
inciting said actor to indicate said first character learning that said first character is a captured laborer;
creating a second video segment via said video camera by filming said indication of said first character learning;
editing and combining at least part of at least said first and second video segments to form a motion picture; and
storing said motion picture on an information storage medium.

32. A program product for relaying a story having a timeline and a unique plot involving characters, said product comprising machine-readable program code for causing, when executed, a machine to perform the process as claimed in claim 20.

33. The process as claimed in claim 20, further comprising:
indicating that a profiteer profits by selling said at least some of said labor performed by said captured laborers on said market and at least maintaining said captured laborers' beliefs that they labor for said at least one of a false entity, a false price, and a false cause,
wherein said interaction comprises said second character indicating to said first character that said second character is at least one of a government agent and a religious agent who desires labor from said first character to help further a worthy cause, and
wherein said first character's belief that said first character will labor for said at least one of a false entity, a false price, and a false cause is at least one of caused and maintained by an electronically generated virtual reality.

34. A process of relaying a story having a timeline and a unique plot involving characters, comprising:
indicating a first character laboring for a compensation comprising a monetary portion and a belief;
indicating that a market value of said monetary portion is substantially less than a market value of said first character's labor;
indicating that a profiteer profits by selling said first character's labor on a market and compensating said first character by at least maintaining said belief using an electronically generated virtual reality; and
indicating said first character learning that said belief is false.

35. The process as claimed in claim 34, further comprising indicating that an interaction in said virtual reality between said first character and a second character causes said first character to labor for said compensation,
wherein said interaction comprises said second character deceiving said first character into believing that said first character will labor for at least one of an false entity, a false price, and a false cause substantially different from a corresponding one of an actual entity, an actual price, and an actual cause.

36. The process as claimed in claim 35, further comprising indicating that said interaction occurs in an electronically generated virtual reality while said first character believes that said first character is not in virtual reality.

37. The process as claimed in claim 35, wherein said interaction comprises said second character indicating to said first character that said second character is a religious agent who desires labor from said first character to help further a worthy cause.

38. The process as claimed in claim 35, wherein said interaction comprises said second character indicating to said first character that said second character is a government agent who desires labor from said first character, and
wherein said interaction further comprises said second character indicating that said labor is desired from said first character to help fulfill a secret government mission to further a worthy cause.

39. The process as claimed in claim 38, wherein said worthy cause comprises combating an evil, said evil comprising a use of virtual reality to cause laborers to labor for, at most, compensations substantially lower than market values of their labors.

40. The process as claimed in claim 34, further comprising:
indicating that entities regularly buy and sell labor on a market;
indicating that at least some of said labor is performed by captured laborers, wherein a captured laborer is one who: a) labors for, at most, a monetary compensation substantially lower than a market value of his or her labor; and b) believes he or she labors for at least one of a false entity, a false price, and a false cause substantially different from a corresponding one of an actual entity, an actual price, and an actual cause; and
indicating that said first character is one of many captured laborers.

41. The process as claimed in claim 40, further comprising indicating that the fact that at least some of said labor is performed by captured laborers is not known to at least a majority of said entities.

42. The process as claimed in claim 40, further comprising indicating said first character learning that said first character is a captured laborer at least in part by said first character purchasing said first character's own labor on said market.

43. The process as claimed in claim 40, further comprising indicating said profiteer becoming a captured laborer.

44. The process as claimed in claim 34, wherein said process is a process of displaying a motion picture having a timeline and a unique plot, comprising:
displaying a video representation of an indication of said first character laboring for said compensation;
displaying a video representation of an indication that a market value of said monetary portion is substantially less than a market value of said first character's labor;
displaying a video representation of an indication that said profiteer profits by selling said first character's labor on a market and compensating said first character by at least maintaining said belief using an electronically generated virtual reality; and
displaying a video representation of an indication of said first character learning that said belief is false.

45. The process as claimed in claim 34, wherein said process is a process of creating a motion picture having a timeline and a unique plot, comprising:
providing a set;
providing a video camera configured to video at least a portion of said set;
inciting an actor to act as said first character;
inciting said actor to indicate laboring for said compensation;
creating a first video segment via a video camera by filming said indication of said laboring by said actor;
inciting said actor to indicate said first character learning that said belief is false;
creating a second video segment via said video camera by filming said indication of said first character learning;
editing and combining at least part of at least said first and second video segments to form a motion picture; and
storing said motion picture on an information storage medium.

46. A program product for relaying a story having a timeline and a unique plot involving characters, said product comprising machine-readable program code for causing, when executed, a machine to perform the process as claimed in claim 34.

47. The process as claimed in claim 34, further comprising:
indicating that entities regularly buy and sell labor on a market;
indicating that at least some of said labor is performed by captured laborers, wherein a captured laborer is one who: a) labors for, at most, a monetary compensation substantially lower than a market value of his or her labor; and b) believes he or she labors for at least one of a false entity, a false price, and a false cause substantially different from a corresponding one of an actual entity, an actual price, and an actual cause;
indicating that said first character is one of many captured laborers; and
indicating that an interaction in said virtual reality between said first character and a second character causes said first character to labor for said compensation,
wherein said interaction comprises said second character deceiving said first character into believing that said first character will labor for at least one of an false entity, a false price, and a false cause substantially different from a corresponding one of an actual entity, an actual price, and an actual cause,
wherein said interaction comprises said second character indicating to said first character that said second character is at least one of a government agent and a religious agent who desires labor from said first character to help further a worthy cause.

48. A process of relaying a story having a timeline and a unique plot involving characters, comprising:
indicating that entities regularly buy and sell labor on a market;
indicating a first character laboring for a compensation comprising a monetary portion and a belief;
indicating that a market value of said monetary portion is substantially less than a market value of said first character's labor;
indicating that a profiteer profits by selling said first character's labor on a market and compensating said first character by at least maintaining said belief;
indicating said first character learning that said belief is false at least in part by said first character purchasing said first character's own labor on said market.

49. The process as claimed in claim 48, further comprising indicating that said profiteer maintains said belief in an electronically generated virtual reality.

50. The process as claimed in claim 48, further comprising indicating that an interaction in said virtual reality between said first character and a second character causes said first character to labor for said compensation,
wherein said interaction comprises said second character deceiving said first character into believing that said first character will labor for at least one of an false entity, a false price, and a false cause substantially different from a corresponding one of an actual entity, an actual price, and an actual cause.

51. The process as claimed in claim 50, further comprising indicating that said interaction occurs in an electronically generated virtual reality while said first character believes that said first character is not in virtual reality.

52. The process as claimed in claim 50, wherein said interaction comprises said second character indicating to said first character that said second character is a religious agent who desires labor from said first character to help further a worthy cause.

53. The process as claimed in claim 50, wherein said interaction comprises said second character indicating to said first character that said second character is a government agent who desires labor from said first character, and
wherein said interaction further comprises said second character indicating that said labor is desired from said first character to help fulfill a secret government mission to further a worthy cause.

54. The process as claimed in claim 53, wherein said worthy cause comprises combating an evil, said evil comprising a use of virtual reality to cause laborers to labor for, at most, compensations substantially lower than market values of their labors.

55. The process as claimed in claim 48, further comprising:
indicating that at least some of said labor is performed by captured laborers, wherein a captured laborer is one who: a) labors for, at most, a monetary compensation substantially lower than a market value of his or her labor; and b) believes he or she labors for at least one of a false entity, a false price, and a false cause substantially different from a corresponding one of an actual entity, an actual price, and an actual cause;
indicating that said first character is one of many captured laborers.

56. The process as claimed in claim 55, further comprising indicating that the fact that said at least some of said labor is performed by captured laborers is not known to at least a majority of said entities.

57. The process as claimed in claim 55, further comprising indicating that a profiteer profits by selling said at least some of said labor performed by said captured laborers on a market and at least maintaining said captured laborers' beliefs that they labor for said at least one of a false entity, a false price, and a false cause.

58. The process as claimed in claim 57, further comprising indicating said profiteer becoming a captured laborer.

59. The process as claimed in claim 48, wherein said process is a process of displaying a motion picture having a timeline and a unique plot, comprising:
displaying a video representation of an indication that entities regularly buy and sell labor on a market;
displaying a video representation of an indication of said first character laboring for said compensation;
displaying a video representation of an indication that a market value of said monetary portion is substantially less than a market value of said first character's labor;
displaying a video representation of an indication that said profiteer profits by selling said first character's labor on a market and compensating said first character by at least maintaining said belief; and
displaying a video representation of an indication of said first character learning that said belief is false at least in part by said first character purchasing said first character's own labor on said market.

60. The process as claimed in claim 48, wherein said process is a process of creating a motion picture having a timeline and a unique plot, comprising:
providing a set;
providing a video camera configured to video at least a portion of said set;
inciting an actor to act as said first character;
inciting said actor to indicate laboring for said compensation;
creating a first video segment via a video camera by filming said indication of said laboring by said actor;
inciting said actor to indicate said first character learning that said belief is false;
creating a second video segment via said video camera by filming said indication of said first character learning;
editing and combining at least part of at least said first and second video segments to form a motion picture; and
storing said motion picture on an information storage medium.

61. A program product for relaying a story having a timeline and a unique plot involving characters, said product comprising machine-readable program code for causing, when executed, a machine to perform the process as claimed in claim 48.
